(19) United States
(12) Patent Application Publication
(10) Pub. No.: US 2024/0214416 A1
(43) Pub. Date: Jun. 27, 2024

(54) VIRTUAL NETWORK DISTRIBUTED DENIAL-OF-SERVICE SCRUBBER

(71) Applicant: Oracle International Corporation, Redwood Shores, CA (US)

(72) Inventors: Leonard Thomas Tracy, Bothell, WA (US); Lucas Michael Kreger-Stickles, Seattle, WA (US)

(73) Assignee: Oracle International Corporation, Redwood Shores, CA (US)

(21) Appl. No.: 18/544,272

(22) Filed: Dec. 18, 2023

Related U.S. Application Data
(60) Provisional application No. 63/434,887, filed on Dec. 22, 2022.

(51) Int. Cl. H04L 9/40

(52) U.S. Cl. CPC H04L 63/1458; H04L 63/1425

(57) ABSTRACT

A novel overlay network DDOS mitigation system (ONDMS) is described for performing DDOS attack mitigation in a virtual network environment. Network traffic received by network resources in overlay networks is monitored. When a potential DDOS attack is detected, ONDMS may initiate a protected mode for a network resource. This may involve creating one or more shadow VNICs for the network resource being protected. While in protected mode, as a result of the one or more shadow VNICs, packets that would otherwise be received by the network resource being protected are instead redirected to one or more alternative destinations (e.g., to a DDOS scrubber system within ONDMS) that are configured to filter and analyze the packets and take appropriate mitigation actions, as needed. This protects the network resource being protected from the potential DDOS attack.

### RELATED APPLICATIONS

This application is a non-provisional of and claims the benefit and priority under 35 U.S.C. 119(e) of U.S. Provisional Application No. 63/434,887, titled “VIRTUAL NETWORK DISTRIBUTED DENIAL-OF-SERVICE SCRUBBER,” filed on Dec. 22, 2022, which is incorporated herein by reference in its entirety for all purposes.

### FIELD

The present disclosure generally relates to the security of computers and networks, and more specifically to techniques for preventing or mitigating distributed denial of service (DDoS) attacks in overlay networks. More specifically, a novel overlay network DDOS mitigation system (ONDMS) is described for performing DDOS attack mitigation in a virtual network environment.

### BACKGROUND

Virtual networking enables cloud service providers (CSPs) to provide cloud services to subscribing customers. A CSP generally provides infrastructure that is used to form overlay networks and to provide cloud services to the CSP's customers. The CSP-provided infrastructure can include various physical and logical resources including various compute, memory, and networking resources (also referred to as network resources). Virtual networking provides customers the facade of a customized, private network on top of shared resources provided in the CSP-provided infrastructure. Fundamental to the virtual network offering is the ability to provide customer-isolation on the shared resources. Resources such as network resources, link bandwidth, and compute resources, are important for the successful delivery of cloud services and impact user experience. Careful monitoring and management of these resources is thus very important.

In today's connected world, the CSP infrastructure is prone to attacks by malicious attackers. A distributed denial of service (DDOS) attack is a common example of such a malicious attack. The source of the attack can be outside the CSP's infrastructure or could even be within the CSP's infrastructure. For example, one or more customers of the CSP may send a large volume of data (e.g., a large number of packets per second) to the same network resource destination (e.g., a virtual network interface card (VNIC), a network virtualization device (e.g., a SmartNIC) implementing one or more VNICs. This high rate of data reception can cause congestion on the NVD or on a link from a top-of-the-rack (TOR) switch to the NVD). This, in turn, could cause exhaustion of compute resources (e.g., CPUs) on the NVD, resulting in failure of the NVD or deterioration in performance of the NVD. This can adversely impact the cloud services provided by the CSP to its customers. Protecting network resources against such DDOS attacks is thus extremely important for the CSP.

### BRIEF SUMMARY

The present disclosure generally relates to the security of computers and networks, and more specifically to techniques for preventing or mitigating distributed denial of service (DDOS) attacks in overlay networks. More specifically, a novel overlay network DDOS mitigation system (ONDMS) is described for performing DDOS attack mitigation in a virtual network environment. Various embodiments are described herein, including methods, systems, non-transitory computer-readable storage media storing programs, code, or instructions executable by one or more processors, and the like.

The techniques described herein can be used in a cloud environment to prevent or mitigate DDOS attacks on cloud infrastructure and also on workloads deployed in the cloud. For example, a cloud service provider (CSP) may provide an overlay network DDOS mitigation system (ONDMS) in its cloud infrastructure, and the system may be used to prevent or mitigate DDOS attacks on the CSP's infrastructure.

In certain embodiments, techniques are provided including a method that comprises monitoring network traffic received by a network virtualization device (NVD) in a cloud service provider infrastructure, the NVD executing a set of one or more virtual network interface cards (VNICs) associated with a set of one or more compute instances in one or more overlay networks provided by the cloud service provider infrastructure, the network traffic destined for at least one compute instance from the set of one or more compute instances; based at least in part on the monitoring, initiating a protected mode for the NVD to protect the NVD from a potential distributed denial of service (DDOS) attack; and while the NVD is in the protected mode, causing one or more packets destined for the set of one or more compute instances to be redirected to a DDOS scrubber system instead of being sent to the NVD.

In yet another embodiment, initiating the protected mode for the NVD comprises: determining the set of one or more VNICs executed by the NVD, the set of one or more VNICs including a first VNIC associated with a first compute instance in the set of one or more compute instances, the first VNIC associated with a first overlay address configured for the first compute instance, where the first overlay address is associated with a substrate address associated with the NVD; creating a set of one or more shadow VNICs for the set of one or more VNICs; associating the set of one or more shadow VNICs with the DDOS scrubber system; and publishing, to the one or more overlay networks provided by the cloud service provider infrastructure, information indicative of the set of one or more shadow VNICs.

In yet another embodiment, causing the one or more packets destined for the set of one or more compute instances to be redirected to the DDOS scrubber system comprises redirecting the one or more packets to the DDOS scrubber system due to the set of one or more shadow VNICs.

In yet another embodiment, the set of one or more VNICs contains a plurality of VNICs; and the set of one or more shadow VNICs contains a single shadow VNIC.

In yet another embodiment, the set of one or more VNICs contains a plurality of VNICs; and the set of one or more shadow VNICs contains a plurality of shadow VNICs, the plurality of shadow VNICs comprising a shadow VNIC corresponding to each VNIC in the plurality of VNICs.

In yet another embodiment, the set of one or more VNICs contains a plurality of VNICs; and the set of one or more shadow VNICs contains a plurality of shadow VNICs, where a number of shadow VNICs in the plurality of shadow VNICs is less than a number of VNICs in the plurality of VNICs.

In yet another embodiment, the DDOS scrubber system includes at least one of a host machine configured to implement at least one shadow VNIC from the set of one or more shadow VNICs or at least one NVD configured to implement at least one shadow VNIC from the set of one or more shadow VNICs.

In yet another embodiment, creating the set of one or more shadow VNICs for the set of one or more VNICs comprises: creating a first shadow VNIC corresponding to the first VNIC associated with the first compute instance, and associating the first overlay address with the first shadow VNIC; and associating the set of one or more shadow VNICs with the DDOS scrubber system comprises associating the first shadow VNIC with a substrate address associated with the DDOS scrubber system.

In yet another embodiment, causing the one or more packets to be redirected to the DDOS scrubber system comprises: for a first packet in the one or more packets, the first packet being destined for the first overlay address configured for the first compute instance; determining that, for the first overlay address, the first packet is to be sent to the substrate address associated with the DDOS scrubber system; and sending the first packet to the DDOS scrubber system.

In yet another embodiment, the method further comprises performing, by the DDOS scrubber system, at least one action on at least one of the one or more packets; where the performing comprises dropping the one or more packets, throttling the one or more packets, or forwarding the one or more packets to the NVD.

In yet another embodiment, the potential distributed denial of service (DDOS) attack is determined when the network traffic is above a predetermined threshold comprising greater than 80% average link utilization for consecutive minutes or bursts of 100% or higher link utilization in consecutive minutes.

In yet another embodiment, the method further comprises exiting the protected mode for the NVD; and after the exiting, for any packet destined for a compute instance from the set of one or more compute instances, sending the packet to the NVD instead of redirecting the packet to the DDOS scrubber system.

In various embodiments, a system is provided that includes one or more data processors and a non-transitory computer readable medium containing instructions which, when executed on the one or more data processors, cause the one or more data processors to perform part or all of one or more methods disclosed herein.

In certain embodiments, techniques are provided including a method that comprises monitoring network traffic received by a first virtual network interface card (VNIC) associated with a first compute instance in an overlay network provided by a cloud service provider infrastructure, the network traffic destined for the first compute instance; based at least in part on the monitoring, initiating a protected mode for the first VNIC to protect the first VNIC from a potential distributed denial of service (DDOS) attack; and while the first VNIC is in the protected mode, causing one or more packets destined for the first compute instance to be redirected to a DDOS scrubber system instead of being sent to a first network virtualization device (NVD) implementing the first VNIC; where the first VNIC is associated with a first overlay address configured for the first compute instance, and the first overlay address is associated with a substrate address associated with the NVD implementing the first VNIC.

In certain embodiments, techniques are provided including a method that comprises monitoring network traffic received by a plurality of network resources in one or more overlay networks provided by a cloud service provider infrastructure, the network traffic destined for a first compute instance; based at least in part on the monitoring, initiating a protected mode for a first network resource from the plurality of network resources to protect the first network resource from a potential distributed denial of service (DDOS) attack, the first network resource being associated with the first compute instance; and while the first network resource is in the protected mode, causing one or more packets destined for the first compute instance to be redirected to a DDOS scrubber system instead of being sent to the first network resource. In various embodiments, a non-transitory computer-readable medium, storing computer-executable instructions which, when executed by one or more processors, cause the one or more processors of a computer system to perform one or more methods disclosed herein.

In various embodiments, a computer-program product, comprising computer program/instructions which, when executed by a processor, cause the processor to perform any of the methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a high level diagram of a distributed environment showing a virtual or overlay cloud network hosted by a cloud service provider infrastructure according to certain embodiments.

FIG. 2 depicts a simplified architectural diagram of the physical components in the physical network within CSPI according to certain embodiments.

FIG. 3 shows an example arrangement within CSPI where a host machine is connected to multiple network virtualization devices (NVDs) according to certain embodiments.

FIG. 4 depicts connectivity between a host machine and an NVD for providing I/O virtualization for supporting multitenancy according to certain embodiments.

FIG. 5 depicts a simplified block diagram of a physical network provided by a CSPI according to certain embodiments.

FIG. 6 is a block diagram illustrating an example architecture of the overlay network DDOS mitigation (ONDMS), according to certain embodiments.

FIG. 7A is a flowchart illustrating the process flow of entering protected mode for a network resource, according to certain embodiments.

FIG. 7B is a flowchart illustrating the process flow of exiting protected mode for a network resource, according to certain embodiments.

FIG. 8 is a flowchart illustrating the process flow of protected mode for an individual VNIC, according to certain embodiments.

FIG. 9 is a flowchart illustrating the process flow of protected mode for a network virtualization device (NVD, e.g., a smartNIC), according to certain embodiments.

FIG. 10 is a flowchart illustrating the packet redirecting in protected mode for an individual VNIC, according to certain embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

FIG. 16 is a flowchart illustrating a generalized process flow of protected mode for a network virtualization device (NVD, e.g., a smartNIC), according to certain embodiments.

FIG. 17 is a flowchart illustrating a generalized process flow of protected mode for an individual VNIC, according to certain embodiments.

FIG. 18 is a flowchart illustrating a generalized process flow of protected mode for a network resource, according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure generally relates to the security of computers and networks, and more specifically to techniques for preventing or mitigating distributed denial of service (DDoS) attacks in overlay networks. More specifically, a novel overlay network DDOS mitigation system (ONDMS) is described for performing DDOS attack mitigation in a virtual network environment.

In certain implementations, network traffic received by various networking resources (also referred to as network resources) in overlay networks provided by a cloud services provider (CSP) is monitored. The networking resources that are monitored can include logical resources such as virtual network interface cards (VNICs), physical resources such as network virtualization devices (NVDs), and others. For example, packets destined for a particular compute instance (i.e., the particular compute instance is the destination of the packets) may be sent to an NVD implementing a VNIC associated with the particular compute instance. The packets sent to that VNIC may be monitored. As another example, an NVD may implement multiple VNICs associated with multiple compute instances. Packets destined for the multiple compute instances are received by the NVD before being forwarded to the destination compute instances. The resource utilization and bandwidth of this NVD may be monitored.

Potential DDOS attack events are detected based upon the monitoring of the network resources. Upon detecting a potential DDOS attack event directed to a particular network resource in the overlay network, the particular resource is put in protected mode. While in protected mode, packets that would otherwise be received by the particular network resource are instead redirected to one or more alternative destinations (e.g., to a DDOS scrubber system) that are configured to filter and analyze the packets and take appropriate mitigation actions, as needed. In certain implementations, one or more shadow VNICs are created for the network resource to be protected, and the shadow VNICs cause the redirection of the network traffic to the DDOS scrubber system. In this manner, the network resource is protected from the potential DDOS attack.

In a public cloud, a virtual network plays an important role in resource utilization, security, flexibility, scalability, and cost saving. Although different customers (or tenants) perceive that they have their dedicated resources in a virtualized network, they actually run on shared resources with adequate security and isolation. Cloud service providers (CSPs) often rely on well-behaved customers and their proper use of equipment for congestion avoidance. However, if certain customers inadvertently or maliciously utilize more resources than what they have been allocated for or paid for, this may affect other customers' experience. For example, one customer sends or receives too much data over the network and causes congestion.

The network is a valuable and limited resource, and may be constrained in two aspects. One aspect is bandwidth (i.e., the number of gigabit per second (Gbps) on a network link). If some customers send or receive much higher network traffic than their allocated bandwidth, these customers may prevent other customers from utilizing a fair share of the bandwidth of the other customers. This poses a concern for the limited bandwidth at a network virtualization device (NVD) (e.g., smartNIC) and compute resources available due to excessive traffic.

Another aspect is packet rate (e.g., packets per second or PPS). Since every packet transmitted or received needs to be processed, which takes up compute resources, too many packets on a network consume excessive compute resources, and, as a result, may constrain other customers' resources. For example, a customer may intentionally use some large instances to send a large number of packets to small instances, and, as a result, overload certain targeted small instances. On the other hand, in some situations, a customer may inadvertently misconfigure a network feature (e.g., virtual traffic access point (VTAP)). In other situations, an application may misbehave. Such situations may cause some instances of cloud resources to generate large volume of traffic directed to a single instance or undersized instances (e.g., VMs).

There are two primary distributed denial of service (DDoS) risks from the virtual network perspective: transmitting and receiving risks. On the transmit side, an important concern is sending at a high packet rate, including control packets or other packets that require additional processing at a high rate, or using too much bandwidth from a compute instance. These factors likely lead to CPU exhaustion on the NVD, and a noisy-neighbor problem for others sharing the same instance. Another concern is bandwidth. If the transmitter has higher bandwidth than that of the receiver, this may potentially lead to congestion at the receiver side, but can be mitigated inside the compute instances by throttling to drop some packets.

On the receiving side, one or more customers may send too much data or too many packets per second to the same destination VNIC, or different destination VNICs on the same NVD (e.g., SmartNIC). Excessive data rate could cause congestion on the link between a top-of-rack (TOR) switch and an NVD, and excessive packet rate could cause CPU exhaustion on the NVD. In an illustrated example, consider a scenario in which traffic is sent by many sender instances. Each instance sends traffic within the allowed limit, but all sender instances' aggregated traffic is beyond the receiver's limit. Suppose each compute instance is allowed to send or receive 10 Gbps of traffic. Thus, each of the ten compute instances sending 10 Gbps traffic is legitimate. However, when all ten compute instances send traffic to a single compute instance, the traffic would result in an aggregate of 100 Gbps, which is well beyond the receiving limit of the receiving compute instance. Furthermore, suppose the receiving compute instance is on a server sharing other instances in a real application cluster (RAC). In that case, the other instances may be impacted by this over-limit aggregated traffic.

Some common DDoS-like problems are due to the misconfiguration of features, such as virtual traffic access point, and application misbehavior, causing large volumes of traffic to small instances (e.g., virtual machines). Such problems may require the CSP to figure out problems before the CSP can fix them. Thus, the problem resolution is a time-consuming process. Sometimes, if the issues are recurring or become real concerns, a CSP may block the customers or terminate the customers' accounts to prevent further issues. These approaches are passive and reactive after the facts.

As indicated above, a novel overlay network DDOS mitigation system (ONDMS) is described herein for performing DDOS attack mitigation in virtual network environments. The ONDMS monitors networking resources, including usage and utilization of the network resources. Based upon the monitoring, the ONDMS determines if and when a protected mode is to be initiated for a particular network resource. When protected mode is initiated for a particular network device, packets that would otherwise be received by the particular network are instead redirected to one or more alternative destinations, such as to a scrubber system that is part of the ONDMS. The scrubber system is configured to filter and analyze the packets and take appropriate mitigation actions, as needed. In certain implementations, one or more shadow VNICs are created for the network resource to be protected, and the shadow VNICs cause the redirection of the network traffic to the ONDMS. In this manner, the network resource is protected from the potential DDOS attack.

Various different network resources can be protected using the ONDMS described in this disclosure. Examples include one or more VNICs, NVDs, and the like. For example, network traffic received by a particular VNIC may be monitored. Based upon a result of monitoring or during monitoring, a protected mode is initiated. In a certain aspect, based upon the monitoring, it may be detected that the particular VNIC is under attack when a traffic volume- or available bandwidth-related threshold associated with the VNIC is met or exceeded. Upon detecting that the particular VNIC is potentially under a DDOS attack, a protected mode is initiated for the particular VNIC. In this protected mode, a shadow VNIC is created for the particular VNIC. Information related to the shadow VNIC is published such that all network traffic (e.g., packets) received by the particular VNIC are instead redirected to the shadow VNIC. The shadow VNIC may be implemented by one or more systems of devices that are different from the system or device implementing the particular VNIC. In this manner, traffic is diverted to a different device or system (referred to as a DDOS scrubber system) from the device or system implementing the particular VNIC. In this manner, the particular VNIC, the device (e.g., an NVD) or system (e.g., a host machine) implementing the particular VNIC is protected from the potential DDOS attack.

The DDOS scrubber system that receives the redirected packets is configured to analyze the redirected packets and take appropriate mitigation actions. Examples of mitigation actions can include dropping all packets while in protected mode, filtering the packets and allowing only some filtered packets to reach the particular VNIC that is the intended destination of the packets, throttling the packets such that a reduced rate of packets is sent to the particular VNIC, and the like. In certain implementations, the DDOS scrubber system includes multiple machines (e.g., a fleet of host machines) that are configured to execute or implement multiple shadow VNICs.

As another example, network traffic received by a particular NVD may be monitored. The NVD may execute or implement one or more VNICs. Based upon a result of monitoring or during monitoring, a protected mode is initiated. In a certain aspect, based upon the monitoring, it may be detected that the particular NVD is under attack when a traffic volume- or available bandwidth-related threshold associated with the particular NVD is met or exceeded. Upon detecting that the particular NVD is potentially under a DDOS attack, the protected mode is initiated for the particular NVD. In this protected mode, one or more shadow VNICs are created for all the VNICs implemented (or executed) by the particular NVD. In one implementation, a single shadow VNIC is created for all the VNICs executed by the particular NVD. In another implementation, one or more shadow VNICs are created for the VNICs executed by the particular NVD, such as one shadow VNIC for each VNIC. Information related to the one or more shadow VNICs is published such that all network traffic (e.g., packets) received by the particular VNICs implemented/executed by the particular NVD are instead redirected to the shadow VNICs. The shadow VNICs may be implemented by one or more systems of devices that are different from the particular NVD. In this manner, traffic is diverted from the NVD under a potential DDOS attack to a different device or system, referred to as a DDOS scrubber system. In this manner, the particular NVD under attack is protected.

Upon continued monitoring of the network resource that has entered protected mode, it may be determined that the network resource can be transitioned from the protected mode to a normal operations mode. In normal operations mode, a shadow VNIC created for a VNIC or an NVD is deleted, and information is published regarding the original VNICs. As a result, communication of network traffic (e.g., packets) received by the original VNICs is resumed without any redirection.

The novel techniques disclosed in the present disclosure provide several benefits. Upon detecting potential DDOS attacks, the ONDMS enters a protected mode to protect specific network resources. The protected mode utilizes a highly scalable DDOS scrubber system that includes multiple machines (e.g., a fleet of host machines) configured to execute or implement one or more shadow VNICs to perform mitigation actions. Once the potential DDOS attacks no longer exist, the ONDMS may transition back to a normal operations mode. The DDOS mitigation process is transparent to the customers and without operator intervention.

For another benefit, imagining a scenario without a separate shadow VNIC, the protected VNIC implemented by an NVD would need to perform the filtering to send only 1 Gbps to a compute instance of each customer under its bandwidth. However, when the aggregated traffic going to the protected VNIC reaches 100 Gbps for its receiving limit of 1 Gbps, the protected VNIC can be overloaded. This situation means no other compute instance would be able to receive traffic because each compute instance that should receive 1 Gbps for the total 100 Gbps on the network link now receives none. Additionally, packets of other customers sharing the same compute instance may be dropped and impacted due to the protected VNIC's ineffective filtering. Thus, utilizing shadow VNICs implemented by a DDoS scrubber system with more computing power, bandwidth, and dedicated mitigation functions (e.g., dropping, filtering, and throttling) can reduce noisy neighbor impact.

Finally, the novel techniques do not need to wait until the network traffic problems have been analyzed and determined to take action, but can proactively redirect network traffic to the SD-VNIC to perform additional filtering. For example, when DDOS attacks initially affect one part of the CSPI and lead to noisy neighbor problems, passive reaction and network analysis may take more effort to identify the cause. The techniques described in the present disclosures can take proactive action by monitoring the network traffic and performing DDOS attack mitigation to prevent further disruption.

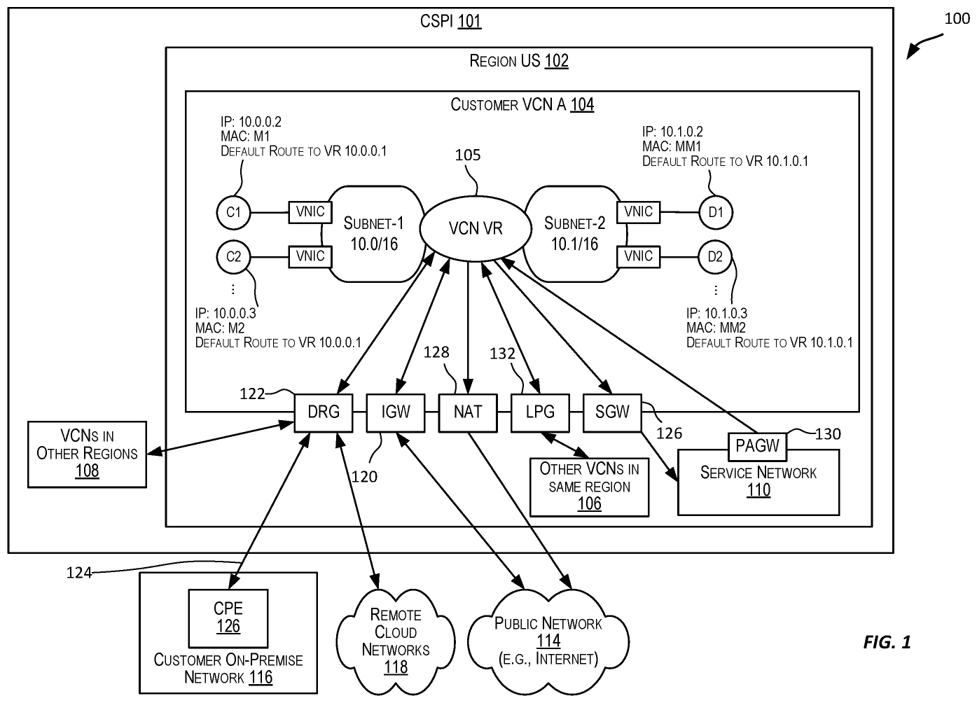

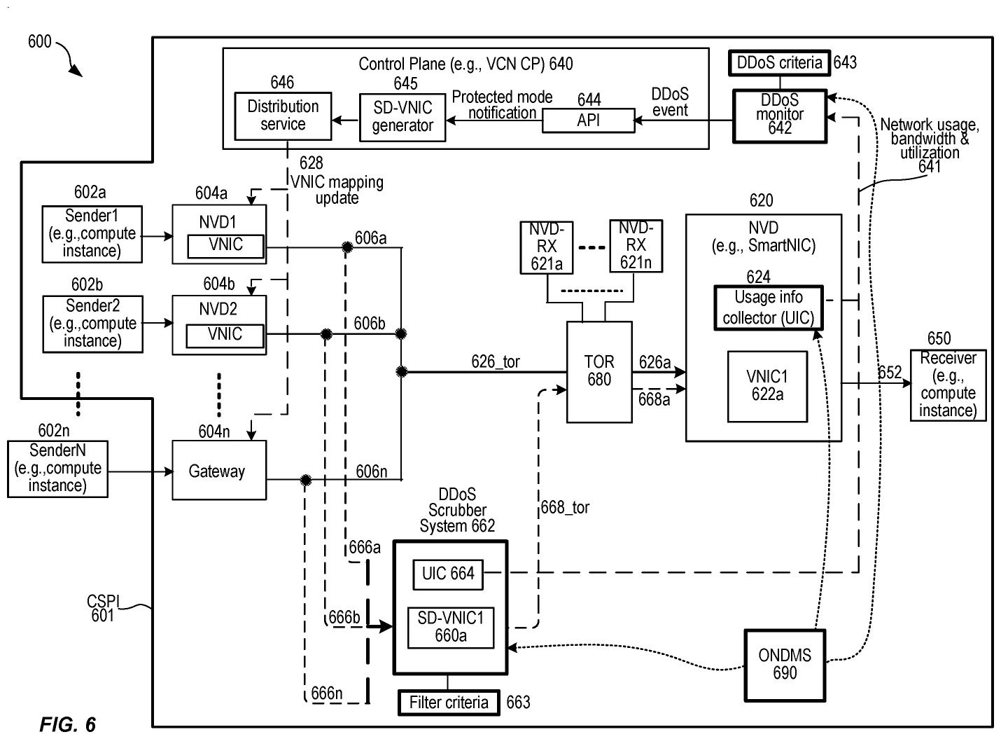

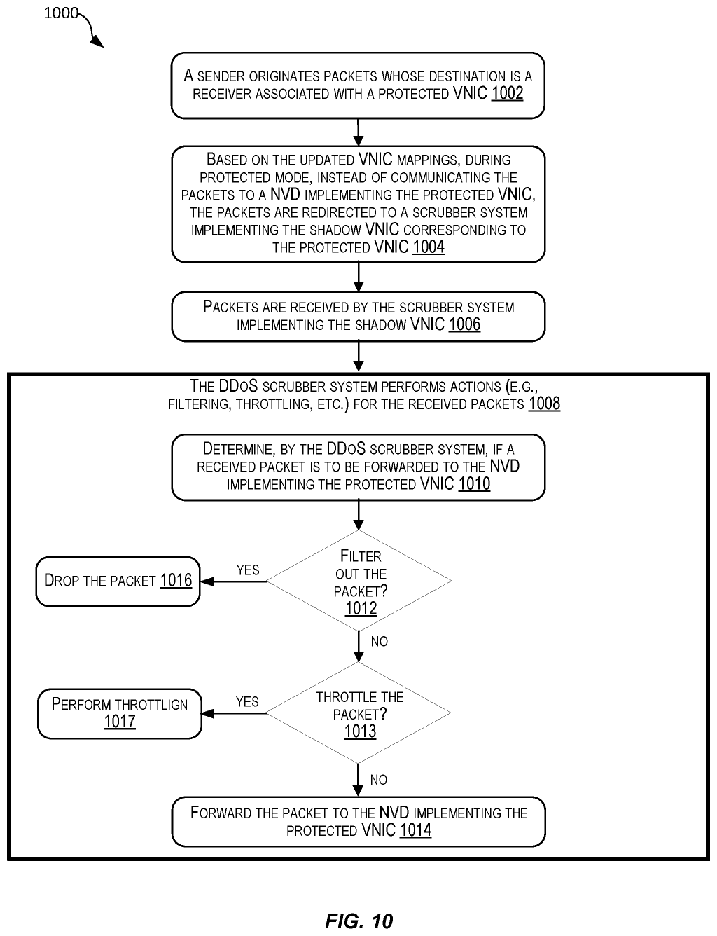

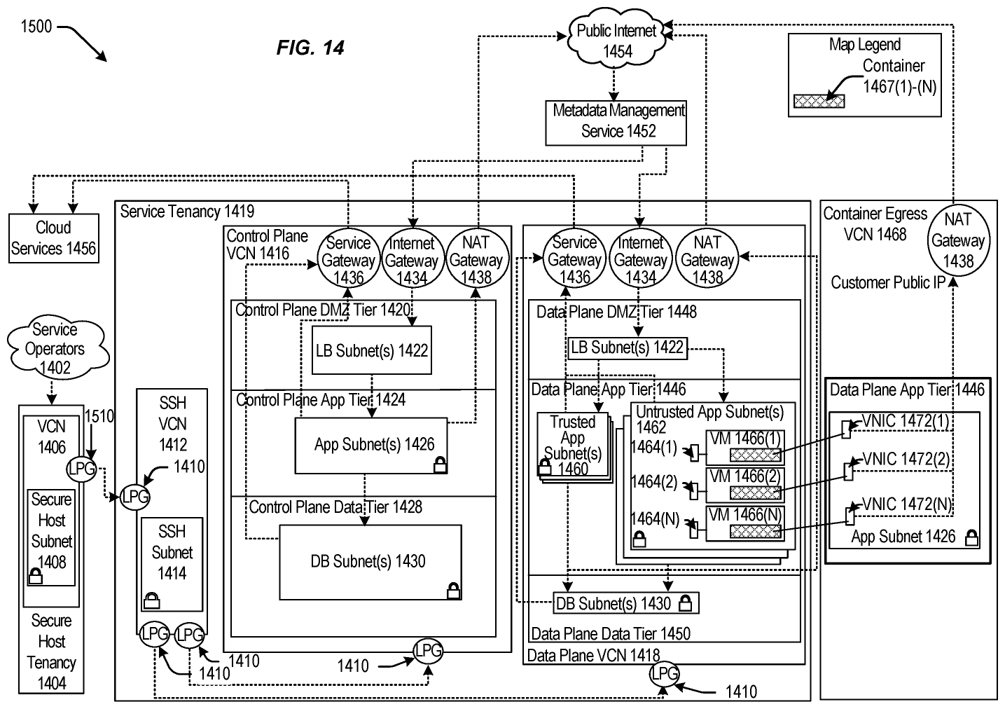

FIGS. 1-5 and the associated description provided in the “Example Virtual Networking Architecture” section below describes networking concepts including network virtualization, substrate networks, overlay networks, VNICs, etc., and provides examples of environments in which certain embodiments described in this disclosure may be implemented. FIGS. 6-9 describe examples and embodiments related to the ONDMS architecture described in this disclosure. FIGS. 10-13 depict examples of architectures for implementing cloud infrastructures for providing one or more cloud services, where the infrastructures may incorporate teachings described herein. FIG. 14 depicts a block diagram illustrating an example computer system or device, according to at least one embodiment.

### Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed—to one or more cloud resources associated with the account.

As noted above, infrastructure as a service (IaaS) is one particular type of cloud computing service. In an laaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN-IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an laaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an laaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the laaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An laaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

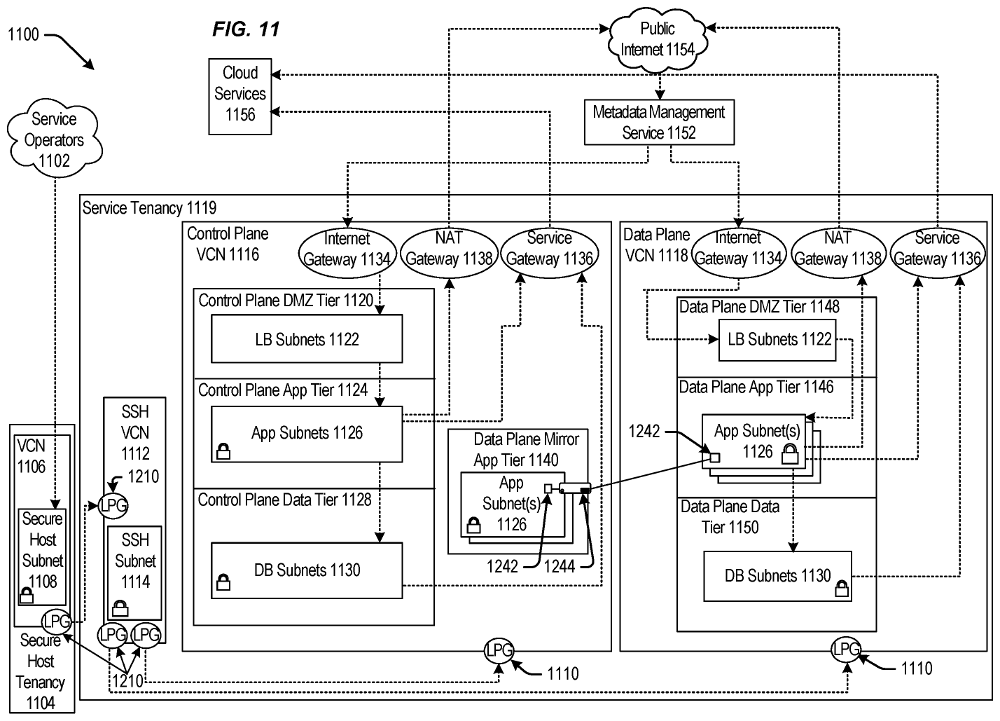

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 11, 12, 13, and 14 (see references 1116, 1216, 1316, and 1416) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, 11, 12, 13, and 15, and are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN A 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of C1. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 11, 12, 13, and 14 (for example, gateways referenced by reference numbers 1134, 1136, 1138, 1234, 1236, 1238, 1334, 1336, 1338, 1434, 1436, and 1438) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

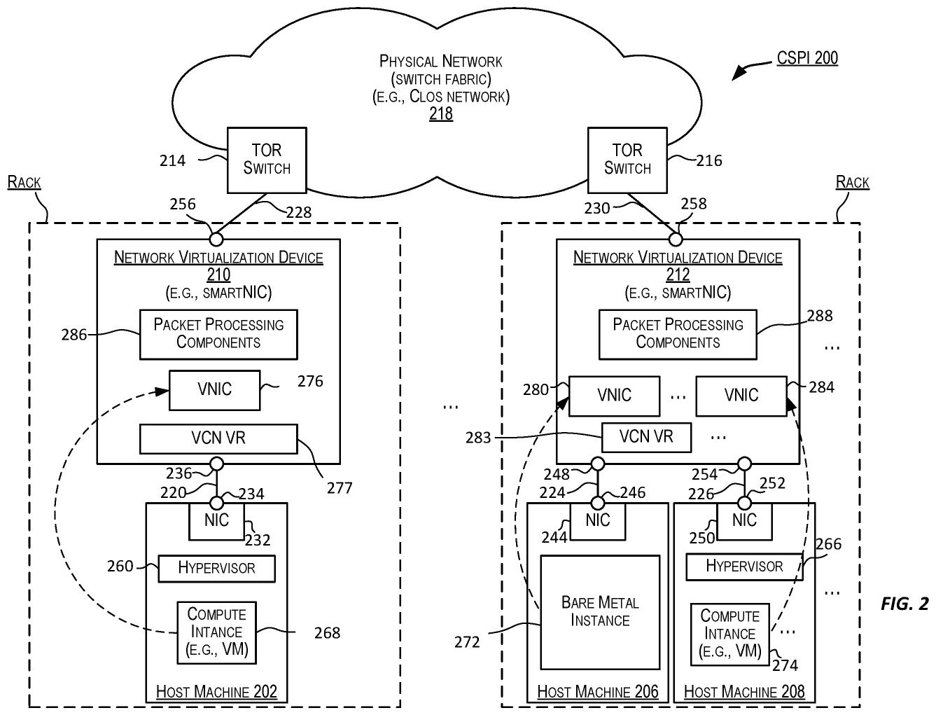

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., laaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

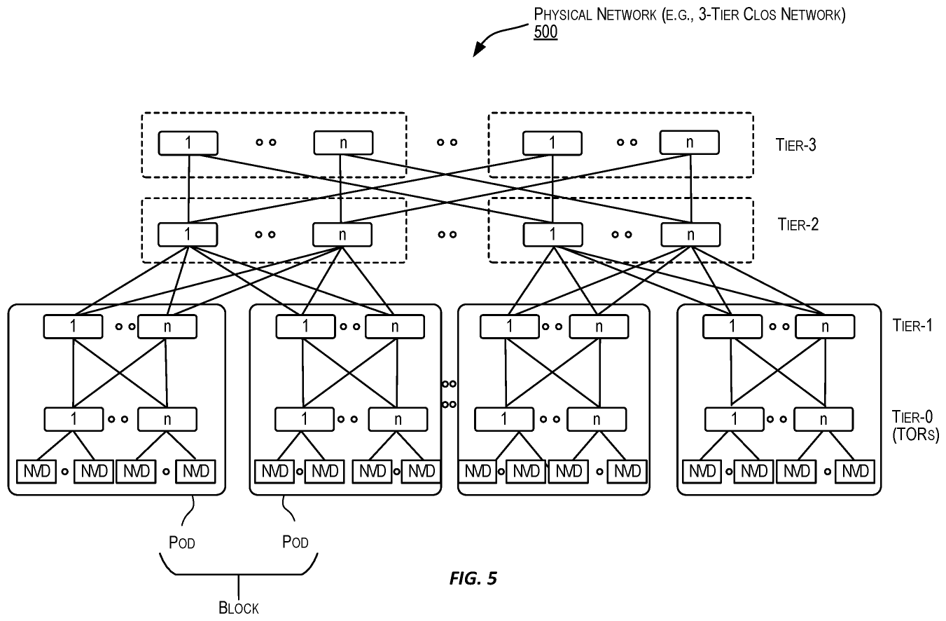

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

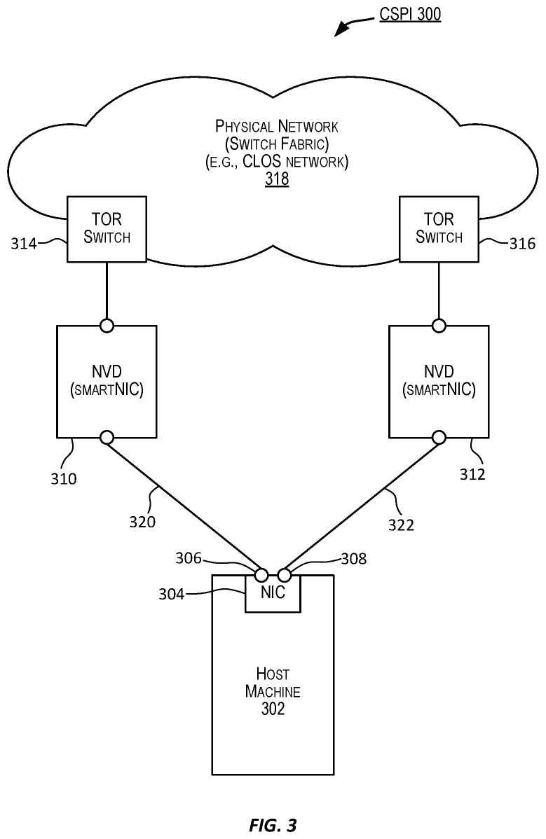

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320, and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 11, 12, 13, and 14 (see references 1116, 1216, 1316, and 1416) and described below. Examples of a VCN Data Plane are depicted in FIGS. 11, 12, 13, and 14 (see references 1118, 1218, 1318, and 1418) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2, NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

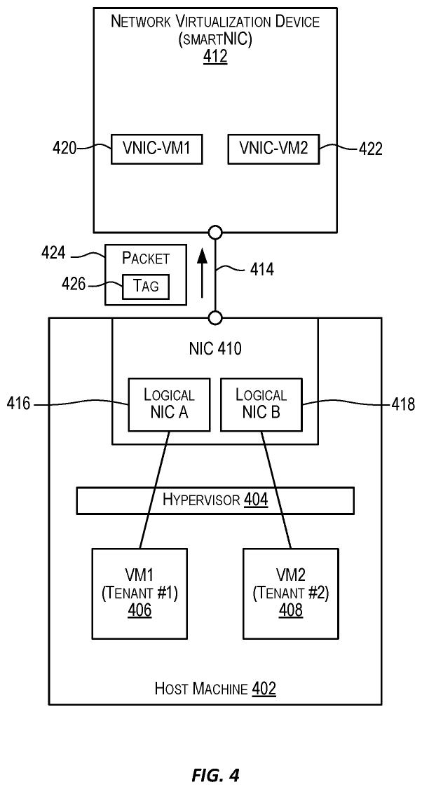

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2. Host machine 402 comprises a physical NIC 410 that is connected to an NVD 412 via link 414. Each of the compute instances is attached to a VNIC that is executed by NVD 412. In the embodiment in FIG. 4, VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example, VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION][.FUTURE USE].<UNIQUE ID>where,
ocid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

### Overlay Network DDOS Mitigation System (ONDMS)

For the purpose of this application, a virtual network interface card (VNIC) provides a virtual network interface for a compute instance associated with that VNIC to enable the compute instance to be part of or connect to a virtual cloud network (VCN). A VNIC may be implemented or executed by an NVD. When a customer launches a compute instance on a server or host machine containing a NIC, the instance communicates using the networking service VNIC. A VNIC enables an instance to connect to a virtual cloud network (VCN) and determines how the instance connects with endpoints inside and outside the VCN. Each VNIC resides in a subnet in a VCN. A VNIC may include a primary private IPv4 address from the subnet the VNIC is in. The primary IP address can be an IPV6 address if an IPV6 prefix is assigned to the subnet. The VNIC may further include MAC address, a VLAN tag, a flag to enable or disable the source/destination check on the VNIC's network traffic, etc. In some embodiments, a compute instance can have multiple associated VNICs, allowing it to participate in multiple different VCNs. In certain implementations, each VNIC is treated as a resource (e.g., a logical resource) within a CSP's infrastructure and is associated with a unique resource ID (e.g., Oracle cloud ID within Oracle cloud infrastructure). Each compute instance has a primary VNIC that is automatically created and attached when the compute instance is created and launched. The primary VNIC is associated with an IP address that resides in a subnet specified by a customer during launch.

An NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by one or more processing units of the NVD. An NVD may be implemented in various different forms. For example, in certain embodiments, an NVD is implemented as an interface card referred to as a smartNIC or an intelligent NIC with an embedded processor onboard. A smartNIC is a separate device from the servers or host machines executing the compute instances and also separate from the physical NICs on the server or host machines.

An NVD can take various forms and implementations. In certain implementations, an NVD may comprise multiple physical ports that enable it to be connected to one or more host machines and to one or more TOR switches. An NVD may receive packets from a host machine (e.g., packets and frames generated by a compute instance hosted by the host machine) via a host-facing port and, after performing the necessary packet processing, may forward the packets to a TOR switch via a network-facing port of the NVD. An NVD may receive packets from a TOR switch via a network-facing port of the NVD and, after performing the necessary packet processing, may forward the packets to a host machine via a host-facing port of the NVD. In this present disclosure, NVD and smartNIC may be used interchangeably.

FIG. 6 is a block diagram illustrating a distributed environment 600 incorporating an exemplary overlay network DDOS mitigation system (ONDMS), according to certain embodiments. The distributed environment 600 including the ONDMS depicted in FIG. 6 is merely an example and is not intended to unduly limit the scope of claimed embodiments. Many variations, alternatives, and modifications are possible. For example, in some implementations, distributed environment 600 may have more or fewer systems or components than those shown in FIG. 6, may combine two or more systems, or may have a different configuration or arrangement of systems. The systems, subsystems, and other components depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As shown in FIG. 6, the distributed environments 600 includes a CSPI 601, and one or more senders 602a-n. Senders are a source of network traffic, including packets. Some senders may be outside the CSPI, and some may be inside CSPI. CSPI may include (1) receivers, such as compute instances hosted by a host machine 650, for receiving the network traffic from the senders; (2) receiver-NVDs (or receiving NVDs), such as NVD-Rx 620, acting as a routing device and locating between senders and receivers; (3) a ONDMS 690 for performing DDOS attack mitigation, and (4) control plane (e.g., VCN control plane) 640.

In some embodiments, senders may send packets to receivers through two different paths. The first path is for the sender inside the CSPI. For example, a compute instance on a sender machine (e.g., 602a) may originate a packet, go through an NVD (e.g., 604a) for the sender, reach NVD (e.g., 620) for a receiver, then arrive at a host machine 650 hosting a compute instance, the final receiver. A second path is for the sender outside the CSPI. For example, a compute instance on a sender machine (e.g., 602n) may originate a packet, go through a gateway (e.g., 604n) for the sender, reach NVD (e.g., 620) for a receiver, then arrive at a host machine 650 hosting a compute instance, the final receiver.

In FIG. 6, 604a-n are NVDs, which can perform transmitting and receiving functions. In the context of DDOS mitigation described in FIG. 6, 604a-n performs a transmitting function for sending packets to receivers in CSPI and may be referred to as NVD-Tx1, NVD-Tx2, etc. The VNICs implemented by NVD 604a-n may also be referred to as VNIC-Tx1, VNIC-Tx2, etc. Similarly, 620 and 621a-n are NVDs that can perform transmitting and receiving functions. However, in the context of DDOS mitigation described in FIG. 6, 620, it performs a receiving function for receiving packets from the senders 602a-n and may be referred to as NVD-Rx or receiver-NVD. The VNICs implemented by NVD 620 may also be referred to as VNIC-Rx1, VNIC-Rx2, etc.

In FIG. 6, on the transmitting side, as discussed above, some senders may be outside the CSPI, and some may be inside the CSPI. For those outside, they communicate with components within the CSPI using gateways. For example, senders 602a and 602b are inside CSPI, while sender 602n is outside the CSPI. An NVD (e.g., NVD-Tx) or a gateway may be associated with each sender. As an example, in FIG. 6, the sender (e.g., 602a) may be in the same VCN as the receiver-NVD 620. Therefore, a transmitting NVD (NVD-Tx1) 604a may be associated with the sender 602a. However, the sender (e.g., 602n) is external to the CSPI where the receiver-NVD 620 is located. Therefore, an internet gateway (IGW) 604n may be associated with the sender 602n.

A gateway may be a virtual interface that is configured for a VCN and enables communication of traffic to and from the VCN to one or more endpoints outside the VCN. Gateway 604n may include different types of gateways, such as Dynamic Routing Gateway (DRG) for facilitating communication of traffic between a cloud infrastructure and customer on-premises networks, internet gateway (IGW) for facilitating communication of traffic between a cloud infrastructure and public network such as the Internet.

Different techniques may be used for implementing gateway 604n. A gateway can be implemented using software only, using hardware, or a combination of software and hardware. A gateway can be implemented as a logical or virtual or overlay network construct, such as a virtual router, that is executed by a host machine or server, a Linux device, an NVD, etc. A gateway can also be implemented as a physical network device, such as a physical router. Gateways can be dynamically configured as needed.

On the receiving side, a receiver-NVD, NVD-Rx (e.g., smartNIC), 620 containing a VNIC-Rx1 622a is illustrated. In some embodiments, the NVD-Rx 620 may contain more than one receiver-NVD, VNIC-Rx, which may be labeled as 622a, 622b, . . . , 622n (not shown). The NVD-Rx 620 further includes a usage information collector (UIC) 624 with a telemetry service that communicates collected usage information to a distributed denial-of-service (DDoS) monitor 642. Further details about the UIC are described below.

In FIG. 6, an overlay network DDOS mitigation system (ONDMS) 690 for performing DDOS mitigation in overlay networks in CSPI may include a DDOS scrubber system 662, and a DDOS monitoring service that comprises a DDOS monitor 642 and multiple usage information collectors (UICs), such as UIC 624 in the receiver-NVD 620, UIC 664 in the DDOS scrubber system 662. In some embodiments, the DDOS monitoring service may monitor the network traffic (e.g., packets) received by receiver-NVDs (e.g., 624) that can forward the packets to the receivers. When the DDOS monitoring service determines that potential DDOS attacks occur, the network traffic may be redirected to the DDOS scrubber system 662.

In certain embodiments, the DDOS scrubber system 662 may be configured to analyze the redirected packets and take appropriate mitigation actions (e.g., filtering and throttling). The DDOS scrubber system 662 comprises a set of host machines or NVDs (e.g., at least one host machine/NVD or a fleet of host machines or NVDs) that are configured to implement one or more shadow VNICs (e.g., SD-VNIC1 660a, and additional SD-VNIC2-N labeled as 660b, . . . , 660n, not shown in FIG. 6). Shadow VNICs may be implemented by one or more systems of devices that are different from receiver-NVDs (e.g., NVD-Rx 620).

In some embodiments, a TOR switch (e.g., 680) may connected to many receiver-NVDs (e.g., 612a to 612n) in addition to NVD-Rx 620. Thus, a packet destined for receiver 650 may reach TOR switch 680 first, which forwards the packets to different receiver NVDs, including receiver-NVD 620 associated with receiver 650.

The ONDMS, in certain embodiments, may include a DDOS monitoring service comprising the UIC 624 in the receiver-NVD 620, UIC 664 in the DDOS scrubber system 662, and DDOS monitor 642. The UIC 624 may monitor and collect resource utilization information (including network usage, bandwidth, and utilization information 641) of network devices (or network resources) in receiver-NVD (NVD-Rx) 620 (e.g., a smartNIC), while UIC 664 may monitor and collect network usage, bandwidth, and utilization information 641 of one or more shadow VNICs (SD-VNICs) in DDOS scrubber system 662. DDOS monitor 642 works with both UIC 624 and UIC 664 to analyze the collected network information related to various network devices. The collected information may include, but is not limited to, CPU utilization information for the receiver-NVD 620, information for the individual receiving VNIC (e.g., VNIC-Rx1 622a) executed by the receiver-NVD 620, bandwidth utilization information for the smartNIC links (host machine facing and to the TOR), etc. The types of collected information may include, but are not limited to, packet rate (i.e., packets per second (PPS)) information, bandwidth-related information, traffic patterns, and trends. In some embodiments, DDOS monitor 642 may be part of the control plane 640. In other embodiments, DDOS monitor 642 may be a separate entity from the control plane 640.

In certain embodiments, the UIC 624 may be placed in many network locations, including TOR, because large DDOS metrics (e.g., high, or heavy traffic) may not be observed at the NVD level. For example, heavy aggregated traffic may occur at the TOR level but not at the individual NVD. The UIC 624 may also monitor traffic from all senders sent to a VNIC on the receiver-NVD 620, and aggregate the traffic at the smartNIC level. In some embodiments, the UIC 624 may be placed outside the NVD (e.g., smartNIC). For example, to protect a receiver-NVD (e.g., 620), the UIC 624 may monitor the links between the NVD and the top of the rack (TOR), and between the NVD and host machines. The monitored and collected traffic (and usage) information is sent to the DDOS monitor to determine whether the traffic meets the requirements and thresholds of DoS.

Another reason that DDOS monitoring service may benefit from placing UIC 624 in many network locations is a scenario that if an NVD is receiving too much data, for example, packets with large data, even though the packet rate (or PPS) is still within limit. Such a scenario may make it difficult for metrics to measure whether there is excessive traffic and report it to the DDOS monitor. As a result, the DDOS attack is hard to detect. Under such a scenario, the DDOS monitoring service may rely on collected metrics from various locations to piece up the whole picture for the receiving NVDs and VNICs.

In some implementations, the DDOS monitoring service performs fined-grained utilization measurements of packet rate (or PPS) and bandwidth utilization. The measurements are also performed at short intervals to capture microbursts compared to significant congestion events that are not captured at the one-minute average. The DDOS monitoring service also has bandwidth metrics at the TOR because sometimes, at the NVD level, the NVD does not know it is receiving higher traffic than it can receive. Thus, the TOR can detect such situations due to, for example, back pressure. As an illustration, the link (e.g., 626_tor) at the TOR switch is 100 Gbps. The NVD (e.g., link 626_tor) may not be aware of the network traffic that is more than 100 Gbps, but the TOR knows because packets are dropped at TOR. The limited bandwidth between the rack and TOR can still cause noisy neighbor problems.

The DDOS monitoring service makes a decision for redirecting (or remapping) traffic based on collected metrics considering senders, receivers, and TOR. When the thresholds for different locations are reached, the monitoring service may send a message or a triggering event (referred to herein as a DDOS event) in CP (e.g., VCN CP) to add protection to a particular VNIC or all VNICs implemented by an NVD, a protecting condition referred to herein as protected mode. Detection of DDOS attack may be based on aggregating the received information (e.g., each sending instance is within the traffic limit, but the aggregated traffic at the receiving end exceeds the traffic limit). In certain embodiments, some predetermined thresholds (also referred to as DDOS criteria 643) for triggering the DDOS event (e.g., potential DDOS attacks), a type of network congestion event, may be used. For example, a DDOS event may be triggered when network congestion has bursts of 100% or higher link utilization in consecutive minutes (e.g., three to five minutes) at the receiving link 626a of the protected VNIC 622a of the receiver-NVD 620, or greater than 80% average link utilization at the receiving link 626a for five to ten consecutive minutes. In some embodiments, the duration for congestion bursts or average link utilization may be shorter or longer depending on applications and needs for sensitivity to the DDOS event. The DDOS monitoring service, monitoring incoming, outgoing, and traffic patterns or trends, either running on or outside the NVD, uses a telemetry service to convey the information to the VCN CP.

Referring to FIG. 6, after the DDOS monitor 642 of the DDOS monitoring service determines that the DDOS event has triggered (i.e., meeting DDOS criteria), the DDOS monitor 642 notifies the CP 640 through API 644 to enter protected mode. The protected mode may be for protecting (1) an individual receiving VNIC 622a on the receiver-NVD or (2) protecting the receiver-NVD 620.

In some embodiments, a shadow VNIC generator 645 in control plane 640 may receive a protected mode notification from the DDOS monitor 642 to perform the processing for creating the shadow VNICs. In the case of protecting a receiver-NVD (e.g., 620), the shadow VNIC generator 645 may determine all the VNICs or certain selected VNICs implemented by the NVD to be protected, then create shadow VNICs for these VNICs. The shadow VNIC generator 645 may then send a signal to distribution service 646 to publish VNIC mappings.

For individual VNIC protection, in certain embodiments, the NVD 620 identifies a receiving VNIC of the NVD to be protected due to excessive traffic for that VNIC, and notifies the VCN CP to create a shadow VNIC (SD-VNIC) for that receiving VNIC (referred to herein as protected VNIC). The ONDMS may redirect the traffic that is received by the protected VNIC to the newly created SD-VNIC. For example, if receiving VNIC, VNIC-Rx1 622a, is selected for protection, a shadow VNIC, SD-VNIC1 660a, may be created by the CP 640. If additional VNIC-Rxs 622b-n (not shown) in the NVD 620 are selected for protection, other SD-VNICs 660b-n (not shown) may be created by the CP 640. For example, another receiving VNIC (e.g., VNIC-Rx2 622b not shown) is selected for protection, then an additional SD-VNIC (e.g., SD-VNIC2 660b) is created for protecting VNIC-Rx2 622b.

In some implementations, the ONDMS may track the VNICs to be protected by storing their corresponding resource identifications (IDs) in a repository, such as memory or a database, of CP 640. Resources within a cloud infrastructure are typically identified using unique resource identifiers (resource IDs). When a resource is created, a resource ID may be assigned to the resource. When UICs 624 and 664 collect usage information, the resource IDs of the VNICs may be tagged with the usage information and sent to the DDOS monitor 642. The DDOS monitor can look up the stored resource IDs in the repository to determine if any of the protected VNICs receive excessive traffic.

For NVD protection, in some embodiments, the entire receiver-NVD 620 may be protected, including the VNIC-Rxs 622a-n (if multiple receiving VNICs exist in the receiver-NVD 620), due to excessive traffic at the NVD level. In other words, an equal number of shadow VNICs (SD-VNICs 660a-n) as the number of the receiving VNICs may be created to protect their corresponding receiving VNICs, VNIC-Rxs 622a-n (i.e., a one-to-one mapping between an SD-VNIC and its protected VNIC, or one SD-VNIC for each VNIC). For example, SD-VNIC1 660a is created to protect VNIC-Rx1 622a, SD-VNIC2 660b (not shown) is created to protect VNIC-Rx2 622b (not shown), and SD-VNICn 660n (not shown) is created to protect VNIC-Rxn 622n (not shown).

In some alternative embodiments, a single SD-VNIC may be created for multiple protected VNICs (i.e., one-to-many mapping between an SD-VNIC and its protected VNICs). For example, during an individual VNIC protection, as discussed above, an SD-VNIC is created for that protected VNIC in an NVD. If an additional receiving VNIC is to be protected, this second VNIC may also be protected by the same SD-VNIC. In other words, the number of SD-VNICs may be fewer than the total number of protected VNICs in the NVD. To further illustrate, for NVD protection, all receiving VNICs on a NVD may be protected by a single SD-VNIC. For example, VNIC-Rxs 622a-n may be protected by a single SD-VNIC1 660a.

In some embodiments, certain network configurations, such as IP and routing and security configurations, may be the same between SD-VNIC and the protected VNIC. For example, an SD-VNIC may have the same IP configurations (e.g., DHCP or static), routing configurations (e.g., policy-based, or dynamic routing), and security configurations (e.g., firewall and access control) as the protected VNIC (i.e., the original destination). The SD-VNIC (e.g., 660a) may be a service VNIC not visible to customers but hosted (or implemented) by a dedicated DDOS scrubber system 662, capable of performing DDOS filtering and/or throttling. In some embodiments, the SD-VNIC may be separately executed by an individual host on a network link between a sender and the protected VNIC of the NVD. The SD-VNIC may be considered a copy of the original protected VNIC (e.g., 622a) in the NVD (e.g., 620) that receives packets from the senders 602a-n. For example, after the DDOS monitoring service detects a DDOS event, the traffic is redirected from the protected VNIC to the SD-VNIC. The SD-VNIC has configurations similar to the protected VNIC and can check security rules, but does not process and send packets to receiver 650 (e.g., one or more compute instances for customers) directly. Instead, the SD-VNIC (e.g., 660a) receives network traffic on behalf of the original protected VNIC (622a), such that the hosting DDOS scrubber system can perform throttling (i.e., intentionally control network traffic to regulate the flow of data packets) and/or filtering (i.e., selectively allowing or blocking specific types of network traffic based on defined filter criteria or rules), which may include, but not limited to, DDOS scrubbing, and stateless security rule enforcement, and deliver the filtered packets to the original protected VNIC. The filtering may be performed by DDOS scrubber system 662 based on certain filter criteria 663.

DDOS attack mitigation or scrubbing may include layer ¾ mitigation and layer 7 mitigation. For example, layer ¾ mitigation may detect and mitigate attacks, such as SYN/ACK floods, UDP reflection amplification, and DNS query floods. Layer 7 mitigation may use a web application firewall (WAF) service to detect and block malicious HTTP/HTTPS traffic.

Stateless security rule enforcement refers to security rules that are stateless. A stateless security rule means no connection tracking is used for any traffic that matches the rule. In contrast to a stateful security rule that tracks the state of established connections and allows return traffic related to those connections, a stateless security rule evaluates each packet independently without considering any prior connections. Security rules are used to control traffic at the packet level, and may include, but are not limited to, security lists and network security groups. Security lists contain a set of ingress and egress rules that specify the types of traffic allowed and apply to all VNICs in a given subnet. Network security groups contain a set of ingress and egress security rules that apply only to a set of VNICs in a single VCN.

Because SD-VNIC has more bandwidth than the protected VNIC, the excessive traffic does not impact other customers directly. The SD-VNIC helps process and prioritize traffic, for example, by applying security rules to drop certain packets or throttling excessive traffic to meet the required limit of the protected VNIC. Thus, the SD-VNIC ensures the traffic delivered to the protected VNIC is legitimate and within the allowed limits.

When ONDMS enters a protected mode for a particular protected VNIC or NVD, the traffic received by the protected VNIC may be redirected to one or more shadow VNICs implemented by a DDOS scrubber system by updating a VNIC mapping. In some embodiments, VNIC mapping may be an association between an overlay address and a substrate address. As discussed earlier, in FIG. 6, an overlay address may be configured for a receiver (e.g., compute instance) 650. VNIC 622a, which enables the receiver 650 to be part of a virtual cloud network, may also be associated with the overlay address. An NVD 620 implementing the VNIC 622a may be configured with a substrate address within CSPI. Similarly, a DDOS scrubber system 662 implementing an SD-VNIC 660a may be configured with a substrate address within CSPI.

When the ONDMS redirects the traffic received by the protected VNIC to the newly created SD-VNIC, it may update the VNIC mappings stored in repositories (e.g., non-volatile memory, database, etc.) for network components, such as NVDs or gateways associated with the source of traffic (i.e., the senders). A repository for each network component (e.g., NVD or gateway) may be inside or external to the component. For example, VNIC mapping may comprise a table that includes an overlay address of a destination receiver and a substrate address of an NVD to which the overlay address is mapped, such that a packet having the destination overlay address can be forwarded to the mapped substrate address in the CSPI. As an example, in normal operations mode, the destination overlay address may be the overlay IP address X of receiver (compute instance) 650, and its mapped substrate address may be the substrate IP address X of receiver-NVD 620 implementing VNIC 622a associated with the receiver 650. After the VNIC mapping update 628 for entering protected mode, the same overlay IP address X of receiver (compute instance) 650 is mapped to a different substrate address, for example, the substrate IP address Y of DDOS scrubber system 662 implementing shadow VNIC, SD-VNIC1 660a. In other words, the mapping update may look like the following:
Mapping for normal operations mode: (overlay IP address X of receiver, substrate IP address X of receiver-NVD)
Mapping for protected mode: (overlay IP address X of receiver, substrate IP address Y of DDOS scrubber system)

In some embodiments, as shown in FIG. 6, the distributed service 646 of the CP 640 performs the VNIC mapping update. The distributed service 646 is a service distributing new mappings to all the NVDs (e.g., 604a and 604b) or gateways (e.g., 604n) associated with the senders, depending on the location of the senders. For example, in one embodiment, if sender 602a is in the same VCN as the receiver-NVD 620, packets may be sent through a local network from a different subnet. An NVD 604a associated with the sender may store the VNIC mappings, and the NVD 604a of sender1 602a just needs to look up the VNIC mapping table to find the destination for its received packets. In another embodiment, if a sender (e.g., 602n) is in a different VCN from where the receiver-NVD 620 is located, the VNIC mapping table may be stored in a local peering gateway (LPG, e.g., 604n). In another embodiment, if a sender (e.g., 602n) is in a different region from where the receiver-NVD 620 is located, the VNIC mapping table may be stored in a dynamic routing gateway (DRG, e.g., 604n). Yet in another embodiment, if a sender (e.g., 602n) is external to the cloud infrastructure the receiver-NVD 620 locates, the VNIC mapping table may be stored in an internet gateway (IGW, e.g., 604n).

To further illustrate in FIG. 6, for individual VNIC protection, suppose before the VNIC mapping updates, traffic 606a from sender-NVD 604a, traffic 606b from sender-NVD 604b, and traffic 606n from sender gateway 604n all go to the same VNIC-Rx1 622a of the receiver-NVD 602. The receiving traffic 626a at VNIC-Rx1 622a monitored by the DDOS monitoring service may exceed a preset threshold and cause the DDOS monitor 642 to notify the CP 640 through API 622 to enter protected mode. The distributed service 646 of the CP 640 may be configured to update the VNIC mappings stored in NVDs or gateways 604a-n through a control link 628 by changing the mapped substrate IP address from receiver-NVD 620 to DDOS scrubber system 662. As a result, the packets of the transmitting traffic 606a-n are redirected to SD-VNIC1 660a through different routes 666a-n. In some embodiments, the new VNIC mappings may cause the NVDs and gateways 604a-n to encapsulate a packet header with a destination address to SD-VNIC1 660a. The DDOS scrubber system 662 implementing SD-VNIC1 660a may perform DDOS filtering and/or throttling and forward the packets to the protected VNIC-Rx1 622a through route 668_tor, then 668a by removing the added/encapsulated packet header. The protected VNIC-Rx1 622a can then perform its normal packet processing, and forward the processed packets to receiver 650.

In certain embodiments, as discussed above, for NVD protection, a similar mechanism as discussed above is applied, and CP 640 may further create additional SD-VNIC2 660b to SD-VNICn 660n (not shown) for their corresponding protected VNIC-Rx2 622b to VNIC-Rxn 622n (not shown) if multiple receiving VNICs exist in the NVD 620. The packets from the senders will go to routes 666a-n instead of 626a-n (where 626b goes to VNIC-Rx2 622b, and 626n goes to VNIC-Rxn 622n separately, not shown). After the DDOS scrubber system 662 implementing SD-VNICs 660a-n performs DDOS filtering and/or throttling, the packets are forwarded to the protected VNIC-Rx 622a-n through route 668_tor, then 668a-n (where 668b goes to VNIC-Rx2 622b, and 668n goes to VNIC-Rxn 622n separately, not shown). The protected VNIC-Rxs 622a-n in NVD 620 can then perform their normal packet processing, and forward the processed packets to receiver 650.

In certain embodiments, the ONDMS may also notify the senders (e.g., 602a-n) to perform throttle on their outgoing traffic after detecting the DDOS event in addition to performing filtering and/or throttling on the receiving end 666a-n.

In certain embodiments, a UIC 664 of the DDOS monitoring service similar to the UIC 624 on receiver-NVD 620 is also available on the DDOS Scrubber system 662 monitoring and collecting traffic information related to an SD-VNIC (e.g., 660a) for an individual protected VNIC, or all SD-VNICs (e.g., 660a-n) for the receiver-NVD 620, to collect traffic information and communicate to DDOS monitor 642 to determine whether the collected information meets DDOS criteria 643 for to ending/exiting the protected mode. For example, when the network link utilization drops below a pre-determined threshold for a pre-determined period of time, for example, the aggregated traffic to the protected VNIC below 80% of link utilization for ten consecutive minutes (e.g., five to ten minutes), the DDOS monitor 642 may notify CP 640 that protected mode exit condition is satisfied. DDOS monitor 642 works with both UIC 624 and UIC 664 to ensure proper transition into and out of a protected mode because the DDOS monitor has visibility into both UICs 624 and 664. The CP 640 may delete the SD-VNIC 660a for the protected VNIC 622a, and send commands to the distributed service 624 to update the VNIC mappings in the NVDs or gateways 604a-n of the senders. For example, the mappings update may look like the following:
Mapping before the update (i.e., for protected mode): (overlay IP address of receiver, substrate IP address of DDOS scrubber system)
Mapping after the update (i.e., for normal operations mode): (overlay IP address of receiver, substrate IP address of receiver-NVD)

Then, the ONDMS can return to normal operations mode. In some embodiments, the SD-VNICs in the DDOS Scrubber system 662 may not be deleted, and only the VNIC mappings are updated.

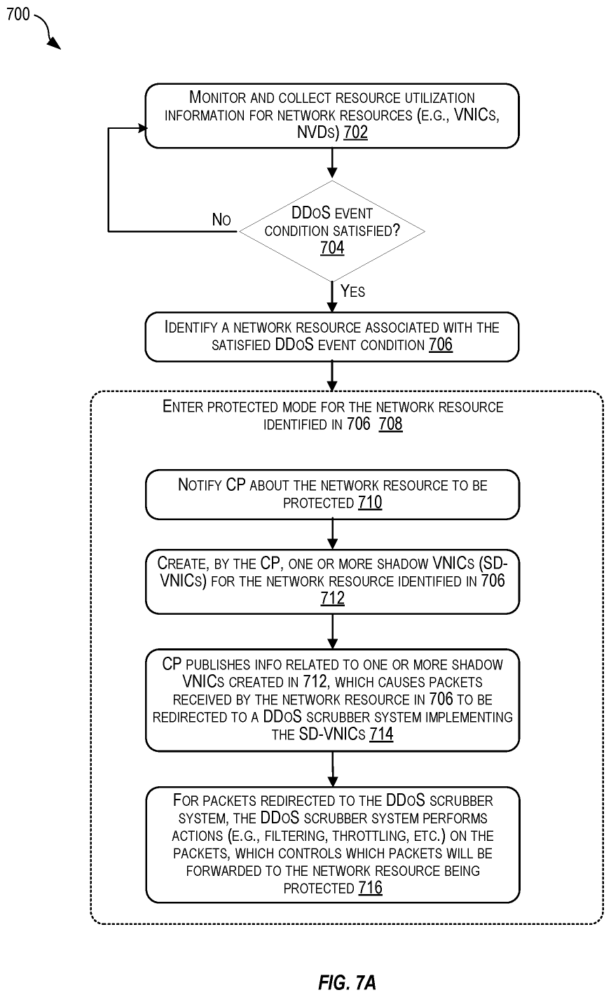

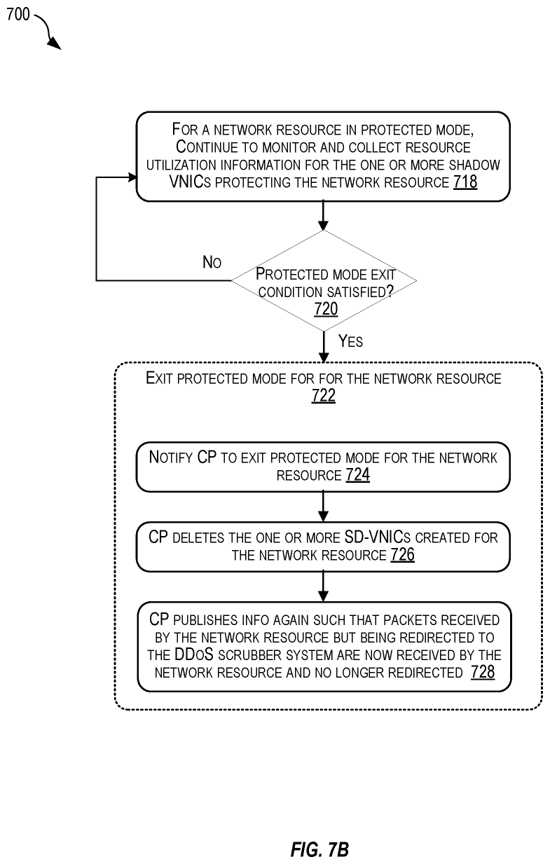

FIG. 7A is a flowchart 700 illustrating the process flow of entering protected mode for a network resource, according to certain embodiments. The processing depicted in FIG. 7A may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7A and described below is intended to be illustrative and non-limiting. Although FIG. 7A depicts the various processing steps occurring in a particular sequence or order, this is not intended to be limiting. In certain alternative embodiments, the steps may be performed in some different order or some steps may also be performed in parallel.

As depicted in FIG. 7A, the process is initiated at 702. At 702, resource utilization information may be monitored and collected for network resources, such as receiving VNICs, receiving NVDs and their associated TORs. For example, the UIC 624 of NVD 620 in FIG. 6 collects the usage information at different levels of network resources, such as VNIC level, NVD level, and TOR level). At 704, based on the information collected in 702, a DDOS event condition for the protected network resources may be determined based on the DDOS criteria 643 set by the ONDMS. For example, DDOS monitor 642 in FIG. 6 may determine whether the aggregated traffic received at link 626a for the protected VNIC-Rx1 622a meets the condition for a DDOS event, for example, pre-determined thresholds as discussed in relation to FIG. 6. If the DDOS event condition for a receiving VNIC to be protected is not met, the process goes to 702 and continues monitoring and collecting network information. If the DDOS event condition for a receiving VNIC to be protected is met, the process goes to 706.

At 706, a network resource associated with the satisfied DDOS event condition may be identified. The network resource may be a VNIC (e.g., 622a), or an NVD (e.g., 620) implementing one or more VNICs. For example, if the network resource is a VNIC, the VNIC-Rx1 622a implemented (or executed) by NVD 620 may be identified for protection based on its resource identification number (e.g., Oracle cloud ID or OCID) by the CP 640 when the aggregated receiving network traffic for VNIC-Rx1 622a satisfies the DDOS event condition. If the network resource is receiver-NVD 620, all VNICs (622a-n) implemented by the receiver-NVD 620 may be identified based on their resource identification numbers when the aggregated receiving network traffic at the NVD level for receiver-NVD 620 satisfies the DDOS event condition. In some embodiments, even though the network resource is an NVD, multiple but not all VNICs (i.e., a few selected VNICs) in the NVD may be identified for protection.

708 may cover 710 to 716. At 708, the ONDMS enters the protected mode for the network resource identified in 706. For example, in certain embodiments, the DDOS monitoring service may enter a status or a particular state of a state machine, indicating the protected mode has been activated for the protected VNIC-Rx1 622a.

At 710, CP is notified about the particular network resource to be protected. For example, DDOS monitor 642 in FIG. 6 may notify CP 640 about the particular VNIC 622a whose aggregated receiving traffic meets the DDOS event condition by providing the corresponding resource ID of that VNIC to be protected. At 712, one or more SD-VNICs are created by the CP (or the shadow VNIC generator 645 in the CP), for the network resource identified in 706. For example, if the network resource is a VNIC, the CP 640 in FIG. 6 may use the resource ID information of the identified VNIC (e.g., 622a) provided by the DDOS monitor 642 to request a cloud resource manager to allocate appropriate resources to create a shadow VNIC, SD-VNIC (e.g., 660a), for that VNIC-Rx1 622a.

For example, if the network resource is an NVD (e.g., 620), the CP 640 in FIG. 6 may use the resource ID information of the identified VNICs (e.g., 622a-n) provided by the DDOS monitor 642 to request a cloud resource manager to allocate appropriate resources to create one or more SD-VNICs for receiver-NVD 620, depending on whether a single SD-VNIC 660a is used to protect the receiver-NVD (i.e., one-to-many mapping between the SD-VNIC and its selectively protected VNICs), or an equivalent number of SD-VNICs (660a-n) are used to protect all VNICs (622a-n) or selected VNICs, implemented by the receiver-NVD 620 (i.e., one-to-one mapping).

At 714, CP may publish information related to the one or more shadow VNICs created in 712, which causes packets received by the network resource to be redirected to a DDOS scrubber system implementing the SD-VNICs. In other words, VNIC mappings stored in NVDs and/or gateways associated with the source of traffic received by the protected VNIC or NVD are updated by CP or other entity in the VCN, such that traffic that is received by the protected VNIC or NVD is redirected to a DDOS scrubber system. For example, in FIG. 6, the VNIC mappings, for example, mapping tables for NVDs and/or gateways 604a-n associated with the senders 602a-n may be updated, such that the SD-VNIC1 660a may replace VNIC-Rx1 622a to become the new destination for senders 602a-n. As a result, the packets that are received by the protected VNIC 622a implemented by receiver-NVD 620 can be redirected to DDOS scrubber system 662 implementing the SD-VNIC 660a instead. For example, in FIG. 6, the transmitting packets from senders 602a-n may go to SD-VNIC1 660a through routes 666a-n instead of going to VNIC-Rx1 622a through routes 626_tor and then 626a.

At 716, for packets redirected to the DDOS scrubber system, the DDOS scrubber system performs actions (e.g., filtering, throttling, etc.) on the packets, which controls which packets will be forwarded to the network resource being protected. In other words, during the protected mode, the DDOS scrubber system 662 implementing one or more SD-VNICs performs DDOS scrubbing, security rule check, and/or throttling on the redirected packets it receives before forwarding to the protected VNIC-Rx1 622a or receiver-NVD 620.

FIG. 7B is a flowchart illustrating the process flow of exiting protected mode for a network resource, according to certain embodiments. The processing depicted in FIG. 7B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7B and described below is intended to be illustrative and non-limiting. Although FIG. 7B depicts the various processing steps occurring in a particular sequence or order, this is not intended to be limiting. In certain alternative embodiments, the steps may be performed in some different order or some steps may also be performed in parallel.

In FIG. 7B, at 718, for the network resource in protected mode, resource utilization information may continue to be monitored and collected for the one or more shadow VNICs protecting the network resource. Because ONDMS is in protected mode and packets are redirected to the DDOS scrubber system, resource utilization information for the protected network resource is observed at the one or more receiving SD-VNICs.. For example, UIC 664 in FIG. 6 may collect resource utilization or network usage information of SD-VNIC1 660a protecting VNIC 622a and communicate to DDOS monitor 642 about the status of the network during the protected mode.

At 720, based on the information collected in 718, a protected mode exit condition for the protected VNIC may be determined based on the DDOS criteria set by the ONDMS, as discussed above in relation to FIG. 6. If the protected mode exit condition is not met, the process goes to 718 and continues monitoring and collecting resource utilization information. If the protected mode exit condition is met, the process goes to 722.

722 may cover 724 to 728. At 722, the ONDMS may exit the protected mode for the network resource, and return to regular mode. For example, in certain embodiments, in FIG. 6, the DDOS monitor 642 of the DDOS monitoring service may enter a status or a state of state machine indicating the protected mode has been deactivated for the protected VNIC-Rx1 622a. At 724, the CP may be notified about the protected mode exit condition and the change of mode. For example, in FIG. 6, the DDOS monitor 642 may notify CP 640 that the protected mode exit condition is met and prepare to exit the protected mode for the protected VNIC-Rx1 622a by providing its corresponding resource ID.

At 726, the one or more SD-VNICs created for the network resource may be deleted or removed to redirect the traffic back to the protected network resource. For example, in certain embodiments, the shadow VNIC generator 645 in CP 640 in FIG. 6 may provide the resource ID of the SD-VNIC1 660a to a cloud resource manager to reclaim the resources corresponding to the SD-VNIC 660a.

At 728, CP may publish information (e.g., the network resource) again such that packets that are received by the network resource but being redirected to the DDOS scrubber system are now received by the network resource and no longer redirected. In other words, VNIC mappings stored in NVDs and/or gateways associated with the source of traffic are updated again by CP (e.g., either VCN CP or other entity in VCN) to reflect the change of mode such that redirected traffic to DDOS scrubber system is received by the protected network resource again. For example, in FIG. 6, the VNIC mappings, such as, mapping tables in NVDs and/or gateways 604a-n associated with the senders 602a-n may be updated, such that the substrate IP address of DDOS scrubber systems removed and replaced by the substrate IP address of receiver-NVD 620. In other words, the mappings change from protected mode to normal operations mode. Then, the process repeats and go to 702.

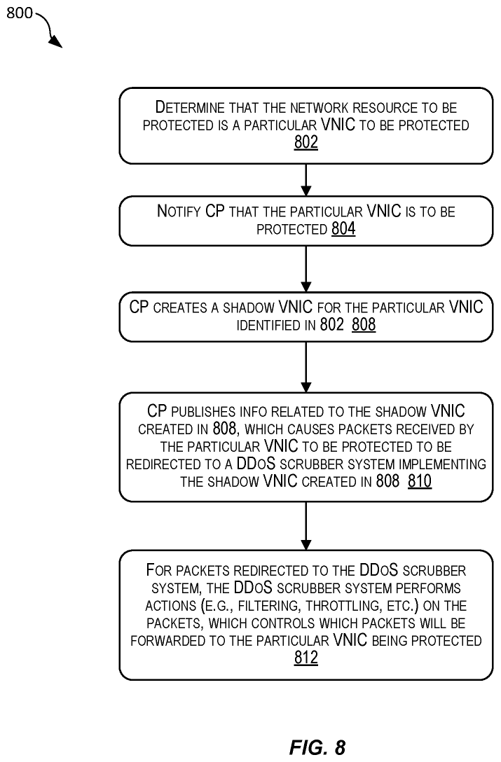

FIG. 8 is a flowchart 800 illustrating processing performed in protected mode for an individual VNIC, according to certain embodiments. The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative embodiments, the steps may be performed in some different order or some steps may also be performed in parallel.

At 802, the network resource to be protected is determined to be a particular VNIC to be protected. For example, in FIG. 6, the VNIC1 (or VNIC-Rx1) 622a implemented by NVD 620 may be identified for protection based on its resource identification number.

At 804, CP may be notified that the particular VNIC is to be protected. For example, DDOS monitor 642 in FIG. 6 may notify CP 640 about the particular VNIC 622a whose aggregated receiving traffic meets the DDOS event condition by providing the corresponding resource ID of that VNIC to be protected.

At 808, a shadow VNIC for the particular VNIC identified in 802 may be created by CP. For example, the CP 640 in FIG. 6 may use the resource ID information of the identified VNIC (e.g., 622a) provided by the DDOS monitor 642 to request a cloud resource manager to allocate appropriate resources to create a shadow VNIC, SD-VNIC (e.g., 660a), for that VNIC-Rx1 622a.

At 810, CP may publish information related to the shadow VNIC created in 808, which causes packets received by the particular VNIC to be protected to be redirected to a DDOS scrubber system implementing the shadow VNIC created in 808. For example, in FIG. 6, the VNIC mapping tables for NVDs and/or gateways 604a-n associated with the senders 602a-n may be updated, such that the mapping for normal operations mode, (overlay IP address of receiver, substrate IP address of receiver-NVD), is updated to become mapping for protected mode, (overlay IP address of receiver, substrate IP address of DDOS scrubber system). As a result, the packets that are received by the protected VNIC 622a implemented by receiver-NVD 620 can be redirected to DDOS scrubber system 662, implementing the SD-VNIC 660a instead.

At 812, for packets redirected to the DDOS scrubber system, the DDOS scrubber system performs actions (e.g., filtering, throttling, etc.) on the packets, which controls which packets will be forwarded to the network resource being protected. In other words, during the protected mode, the DDOS scrubber system 662 implementing SD-VNIC 660a may perform DDOS scrubbing, security rule check, and/or throttling on the redirected packets it receives before forwarding to the protected VNIC-Rx1 622a.

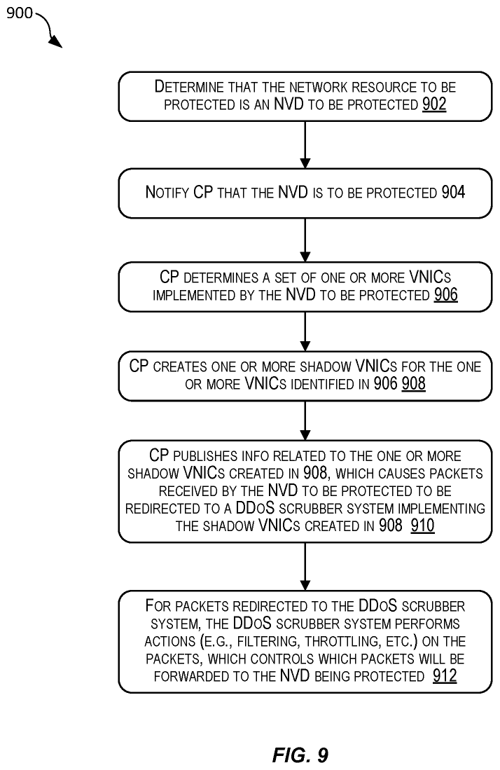

FIG. 9 is a flowchart 900 illustrating processing performed in protected mode for an NVD (e.g., a smartNIC), according to certain embodiments. The processing depicted in FIG. 9 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 9 and described below is intended to be illustrative and non-limiting. Although FIG. 9 depicts the various processing steps occurring in a particular sequence or order, this is not intended to be limiting. In certain alternative embodiments, the steps may be performed in some different order, or some steps may also be performed in parallel.

As depicted in FIG. 9, the process is initiated in 902. The network resource to be protected is determined to be a particular NVD to be protected. For example, in FIG. 6, since the network resource to be protected is receiver-NVD 620, all VNICs (622a-n) implemented by the receiver-NVD 620 may be identified based on their resource identification numbers. In some embodiments, a few selected VNICs in the NVD may be identified for protection, instead of all VNICs implemented by the NVD.

At 904, CP is notified about the particular network resource to be protected. For example, DDOS monitor 642 in FIG. 6 may notify CP 640 about the particular receiver-NVD 620 to be protected whose aggregated receiving traffic meets the DDOS event condition.

At 906, CP may determine a set of one or more VNICs implemented by the NVD to be protected. For example, when CP creates receiver-NVD 620, the CP may have information about which VNICs implemented by the NVD should be protected in case of DDOS attack. The resource IDs of these selected/identified VNICs to be protected in the receiver-NVD 620 may be obtained.

At 908, one or more shadow VNICs for the one or more VNICs identified in 906 are created by the CP. For example, the CP 640 in FIG. 6 may use the resource IDs of the selected/identified VNICs to be protected to request a cloud resource manager to allocate appropriate resources to create one or more SD-VNICs for the identified VNICs. In some embodiments, a single SD-VNIC 660a may be created to protect the identified VNICs, as in the one-to-many mapping relationship, discussed in FIG. 6. In other embodiments, one SD-VNIC may be created to protect each identified VNIC, as the one-to-one mapping relationship, discussed in FIG. 6.

At 910, CP may publish information related to the one or more shadow VNICs created in 908, which causes packets received by the NVD to be redirected to a DDOS scrubber system implementing the shadow VNICs created in 908. For example, in FIG. 6, the VNIC mapping tables for NVDs and/or gateways 604a-n associated with the senders 602a-n may be updated, such that the mapping for normal operations mode, (overlay IP address of receiver, substrate IP address of receiver-NVD), is updated to become mapping for protected mode, (overlay IP address of receiver, substrate IP address of DDOS scrubber system). As a result, packets that are received by the receiver-NVD 620 are redirected to a DDOS scrubber system 662 implementing the one or more shadow VNICs.

At 912, for packets redirected to the DDOS scrubber system, the DDOS scrubber system performs actions (e.g., filtering, throttling, etc.) on the packets, which controls which packets will be forwarded to the NVD being protected. In other words, during the protected mode, the DDOS scrubber system 662 implementing one or more SD-VNICs performs DDOS scrubbing, security rule check, and/or throttling on the redirected packets it receives before forwarding to the protected receiver-NVD 620.

FIG. 10 is a flowchart 1000 illustrating the packet redirecting in protected mode for an individual VNIC, according to certain embodiments. The processing depicted in FIG. 10 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 10 and described below is intended to be illustrative and non-limiting. Although FIG. 10 depicts the various processing steps occurring in a particular sequence or order, this is not intended to be limiting. In certain alternative embodiments, the steps may be performed in some different order or some steps may also be performed in parallel.

FIG. 10 further illustrates details in 716 in FIG. 7A. At 1002, a sender originates packets whose destination is a receiver entity associated with a protected VNIC. For example, in FIG. 6, one (e.g., 602a) of the senders 602a-n may originate packets to be destined for receiver (e.g., a compute instance) 650 associated with a protected VNIC-Rx1 622a executed by NVD 620. The packets may be sent through one (e.g., 606a) of the network links 606a-n, then 626_tor and 626a, to reach 652.

At 1004, based on the updated VNIC mappings, during protected mode, instead of communicating the packets to an NVD implementing the protected VNIC, the packets are redirected to a DDOS scrubber system implementing the shadow VNIC corresponding to the protected VNIC. For example, in FIG. 6, the updated VNIC mappings in the NVD 604a associated with the sender 602a cause the packets on link 606a to be redirected to network link 666a to reach SD-VNIC1 660a instead of to the protected VNIC-Rx1 622a through network links 626_tor and 626a. At 1006, packets are received by DDOS scrubber system implementing the SD-VNIC. For example, in FIG. 6, after the VNIC mapping update, the created SD-VNIC 660a for the protected VNIC 622a, and not the protected VNIC 622a, receives the packets.

At 1008, the DDOS scrubber system performs actions (e.g., filtering, throttling, etc.) for the received packets. 908 can be further broken down into sub-steps 1010 to 1017. At 1010, the DDOS scrubber system determines whether a received packet is to be forwarded to the NVD implementing the protected VNIC. For example, the DDOS scrubber system may perform throttling and/or filtering by dropping certain packets to manage bandwidth usage, reduce congestion, or enforce policies on data transfer rates. The DDOS scrubber system may also perform DDOS scrubbing, and stateless security rule enforcement to filter packets, as discussed in relation to FIG. 6.

At 1012, if the packet is filtered, the packet may be dropped at 1016. If the packet is not filtered, the processing proceeds to 1013. At 1013, if the packet is to be throttled, the DDoS scrubber system performs the throttling at 1017. If the packet is not to be throttled, the processing proceeds to 1014. At 1014, the packet, which is not filtered or throttled, is forwarded to the NVD implementing the protected VNIC. For example, in FIG. 6, DDOS scrubber system 662 implementing SD-VNIC1 660a may forward the permitted packet after throttling and/or filtering to receiver-NVD 620 implementing the protected VNIC 622a, which may then further forward the packet to a receiver, for example, a compute instance 650.

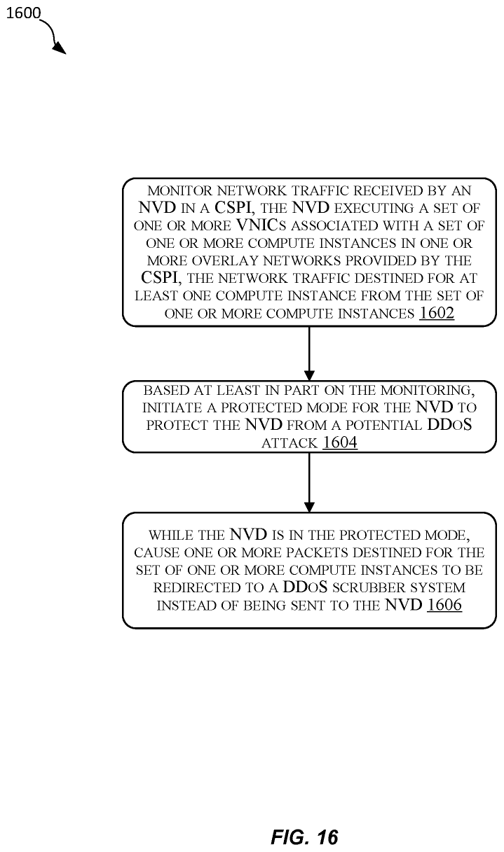

FIG. 16 is a flowchart 1600 illustrating a generalized process flow of protected mode for a network virtualization device (NVD, e.g., a smartNIC), according to certain embodiments. The processing depicted in FIG. 16 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 16 and described below is intended to be illustrative and non-limiting. Although FIG. 16 depicts the various processing steps occurring in a particular sequence or order, this is not intended to be limiting. In certain alternative embodiments, the steps may be performed in some different order, or some steps may also be performed in parallel.

As depicted in FIG. 16, the process is initiated at 1602. Network traffic received by an NVD in a CSPI is monitored. The NVD may execute a set of one or more VNICs associated with a set of one or more compute instances in one or more overlay networks provided by the CSPI. The network traffic may be destined for at least one compute instance from the set of one or more compute instances.

At 1604, based at least in part on the monitoring, a protected mode for the NVD to protect the NVD from a potential DDOS attack may be initiated.

At 1606, while the NVD is in protected mode, one or more packets destined for the set of one or more compute instances may be caused to be redirected to a DDOS scrubber system instead of being sent to the NVD.

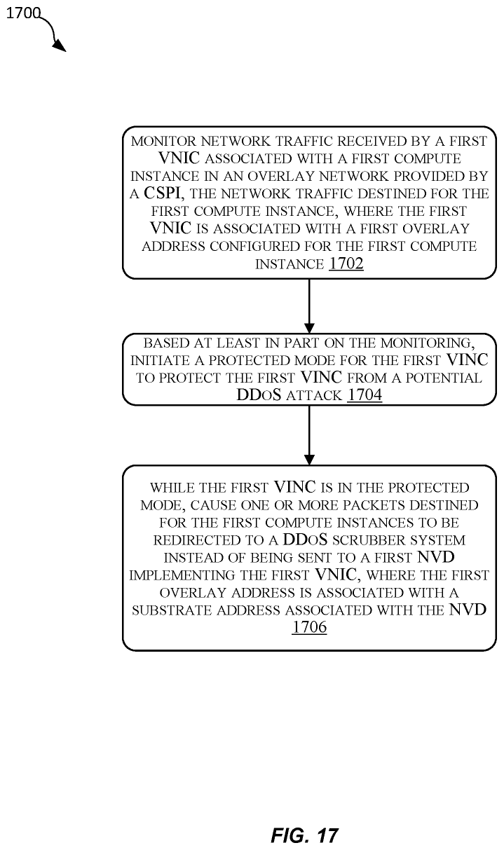

FIG. 17 is a flowchart 1700 illustrating a generalized process flow of protected mode for an individual VNIC, according to certain embodiments. The processing depicted in FIG. 17 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 17 and described below is intended to be illustrative and non-limiting. Although FIG. 17 depicts the various processing steps occurring in a particular sequence or order, this is not intended to be limiting. In certain alternative embodiments, the steps may be performed in some different order, or some steps may also be performed in parallel.

As depicted in FIG. 17, the process is initiated at 1702. Network traffic received by a first VNIC associated with a first compute instance in an overlay network provided by a CSPI may be monitored. The network traffic may be destined for the first compute instance. The first VNIC may be associated with a first overlay address configured for the first compute instance.

At 1704, based at least in part on the monitoring, a protected mode for the first VINC to protect the first VINC from a potential DDOS attack may be initiated.

At 1706, while the first VINC is in the protected mode, one or more packets destined for the first compute instances may be caused to be redirected to a DDOS scrubber system instead of being sent to a first NVD implementing the first VNIC. The first overlay address may be associated with a substrate address associated with the NVD.

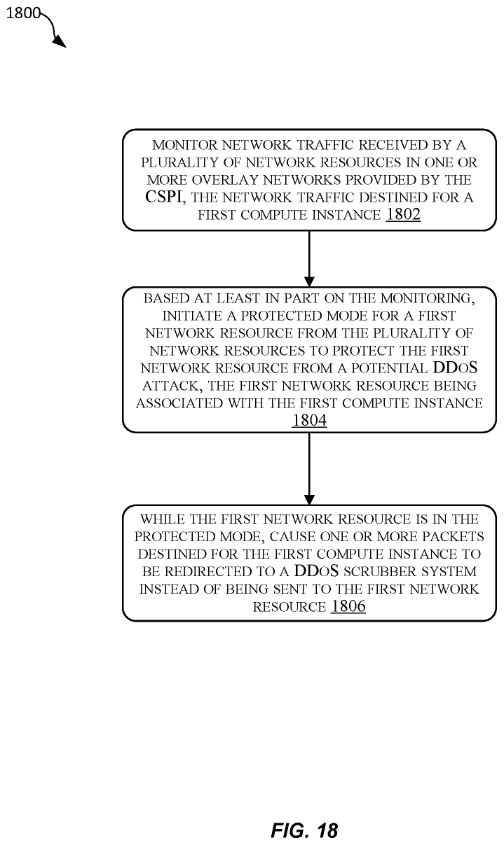

FIG. 18 is a flowchart 1800 illustrating a generalized process flow of protected mode for a network resource, according to certain embodiments. The processing depicted in FIG. 18 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 18 and described below is intended to be illustrative and non-limiting. Although FIG. 18 depicts the various processing steps occurring in a particular sequence or order, this is not intended to be limiting. In certain alternative embodiments, the steps may be performed in some different order, or some steps may also be performed in parallel.

As depicted in FIG. 18, the process is initiated at 1802. Network traffic received by a plurality of network resources in one or more overlay networks provided by the CSPI may be monitored. The network traffic may be destined for a compute instance.

At 1804, based at least in part on the monitoring, a protected mode for a first network resource from the plurality of network resources to protect the first network resource from a potential DDOS attack may be initiated. The first network resource may be associated with the first compute instance.

At 1806, while the first network resource is in protected mode, one or more packets destined for the first compute instance may be caused to be redirected to a DDOS scrubber system instead of being sent to the first network resource.

At 1808, while the first network resource is in the protected mode, whether any packet from the one or more packets is to be forwarded to the first network resource may be determined. For example, the DDOS scrubber system may determine whether any packet from the one or more packets is to be forwarded to the first NVD by performing packet dropping, throttling, and filtering.

### Example Cloud Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an laaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, laaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, laaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users′, or other customers′, resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the laaS provider and may be stored on the service tenancy 1119, which may be isolated from public Internet 1154.

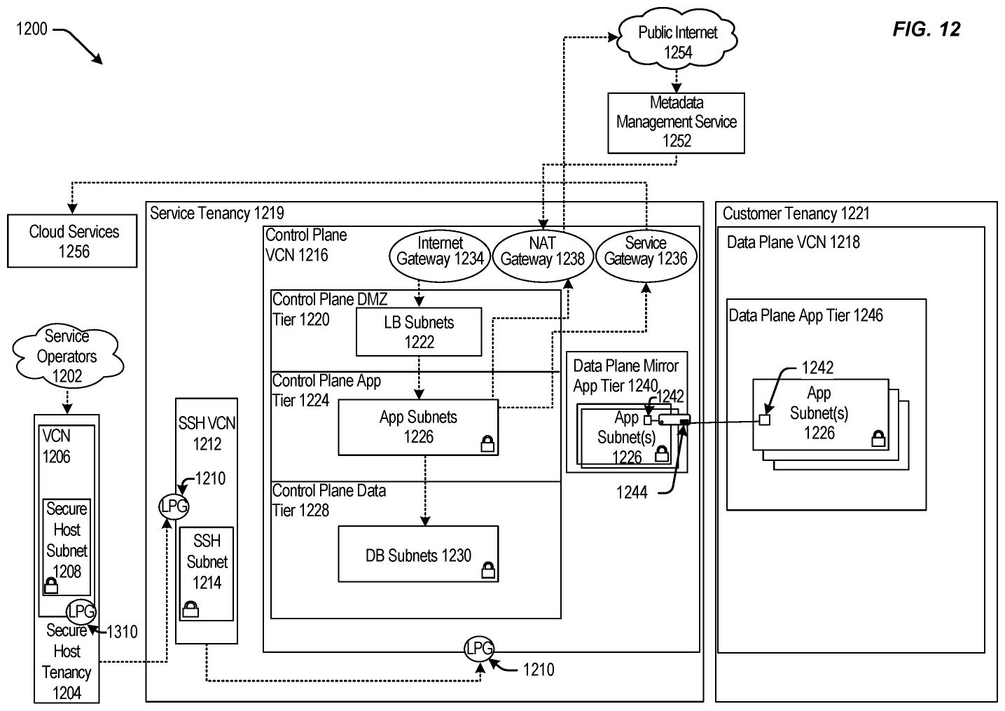

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with,

### Deployment 11 in Region 2.

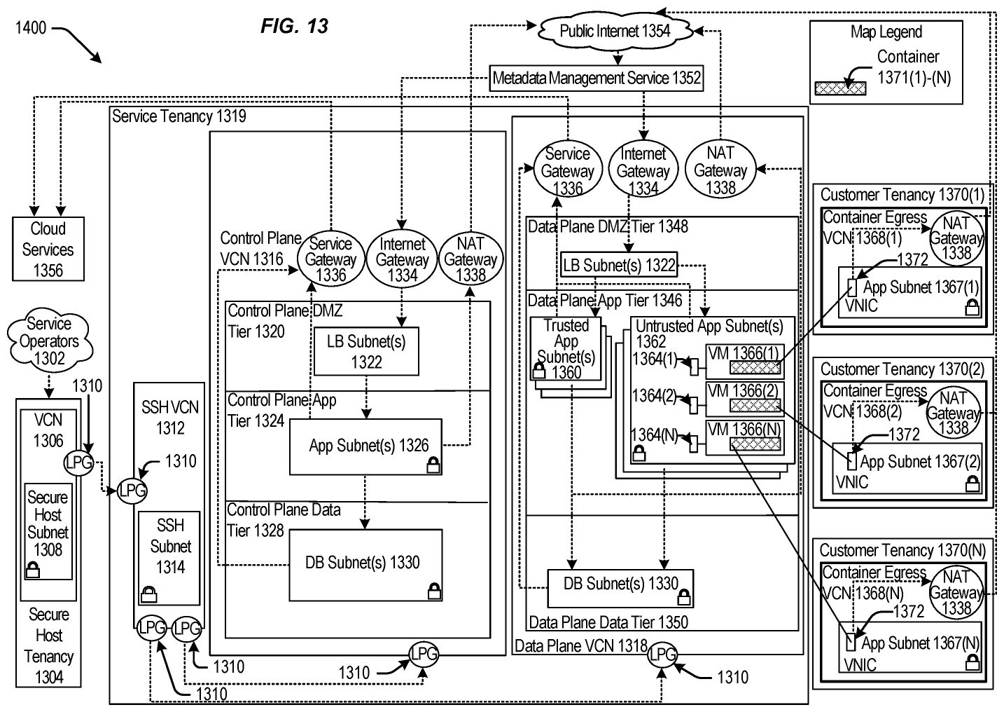

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the laaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the laaS systems may have more or fewer components than shown in the figures, may combine two or more components, or may have a different configuration or arrangement of components.

In certain embodiments, the laaS systems described herein may include a suite of applications, middleware, and database service offerings that are delivered to a customer in a self-service, subscription-based, elastically scalable, reliable, highly available, and secure manner. An example of such an laaS system is the Oracle Cloud Infrastructure (OCI) provided by the present assignee.

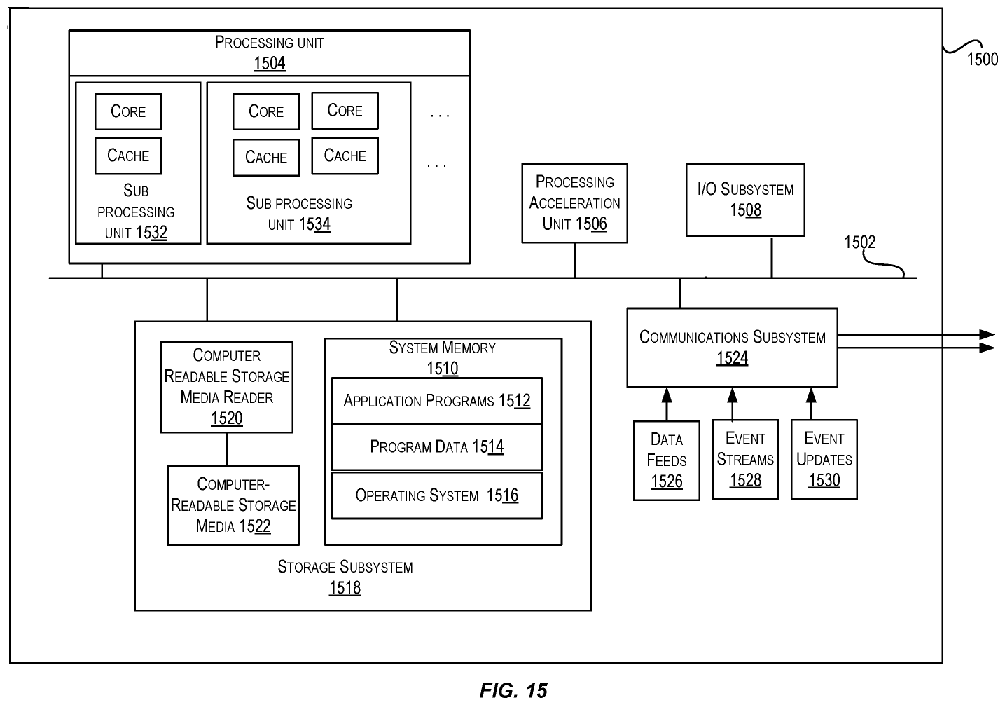

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM

(EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
monitoring network traffic received by a network virtualization device (NVD) in a cloud service provider infrastructure, the NVD executing a set of one or more virtual network interface cards (VNICs) associated with a set of one or more compute instances in one or more overlay networks provided by the cloud service provider infrastructure, the network traffic destined for at least one compute instance from the set of one or more compute instances;
based at least in part on the monitoring, initiating a protected mode for the NVD to protect the NVD from a potential distributed denial of service (DDOS) attack; and
while the NVD is in the protected mode, causing one or more packets destined for the set of one or more compute instances to be redirected to a DDOS scrubber system instead of being sent to the NVD.

2. The method of claim 1, wherein initiating the protected mode for the NVD comprises:
determining the set of one or more VNICs executed by the NVD, the set of one or more VNICs including a first VNIC associated with a first compute instance in the set of one or more compute instances, the first VNIC associated with a first overlay address configured for the first compute instance, wherein the first overlay address is associated with a substrate address 17 associated with the NVD;
creating a set of one or more shadow VNICs for the set of one or more VNICs;
associating the set of one or more shadow VNICs with the DDOS scrubber system; and
publishing, to the one or more overlay networks provided by the cloud service provider infrastructure, information indicative of the set of one or more shadow VNICs.

3. The method of claim 2, wherein causing the one or more packets destined for the set of one or more compute instances to be redirected to the DDOS scrubber system comprises redirecting the one or more packets to the DDOS scrubber system due to the set of one or more shadow VNICs.

4. The method of claim 2, wherein:
the set of one or more VNICs contains a plurality of VNICs; and
the set of one or more shadow VNICs contains a single shadow VNIC.

5. The method of claim 2, wherein:
the set of one or more VNICs contains a plurality of VNICs; and
the set of one or more shadow VNICs contains a plurality of shadow VNICs, the plurality of shadow VNICs comprising a shadow VNIC corresponding to each VNIC in the plurality of VNICs.

6. The method of claim 2, wherein:
the set of one or more VNICs contains a plurality of VNICs; and
the set of one or more shadow VNICs contains a plurality of shadow VNICs, wherein a number of shadow VNICs in the plurality of shadow VNICs is less than a number of VNICs in the plurality of VNICs.

7. The method of claim 2, wherein the DDOS scrubber system includes at least one of a host machine configured to implement at least one shadow VNIC from the set of one or more shadow VNICs or at least one NVD configured to implement at least one shadow VNIC from the set of one or more shadow VNICs.

8. The method of claim 2, wherein:
creating the set of one or more shadow VNICs for the set of one or more VNICs comprises:
creating a first shadow VNIC corresponding to the first VNIC associated with the first compute instance, and
associating the first overlay address with the first shadow VNIC; and
associating the set of one or more shadow VNICs with the DDOS scrubber system comprises associating the first shadow VNIC with a substrate address associated with the DDOS scrubber system.

9. The method of claim 8, wherein causing the one or more packets to be redirected to the DDoS scrubber system comprises:
for a first packet in the one or more packets, the first packet being destined for the first overlay address configured for the first compute instance;
determining that, for the first overlay address, the first packet is to be sent to the substrate address associated with the DDOS scrubber system; and
sending the first packet to the DDOS scrubber system.

10. The method of claim 1, further comprising:
performing, by the DDOS scrubber system, at least one action on at least one of the one or more packets;
wherein the performing comprises dropping the one or more packets, throttling the one or more packets, or forwarding the one or more packets to the NVD.

11. The method of claim 1, wherein the potential distributed denial of service (DDOS) attack is determined when the network traffic is above a predetermined threshold comprising greater than 80% average link utilization for consecutive minutes or bursts of 100% or higher link utilization in consecutive minutes.

12. The method of claim 1, further comprising:
exiting the protected mode for the NVD; and
after the exiting, for any packet destined for a compute instance from the set of one or more compute instances, sending the packet to the NVD instead of redirecting the packet to the DDOS scrubber system.

13. A method, comprising:
monitoring network traffic received by a first virtual network interface card (VNIC) associated with a first compute instance in an overlay network provided by a cloud service provider infrastructure, the network traffic destined for the first compute instance;
based at least in part on the monitoring, initiating a protected mode for the first VNIC to protect the first VNIC from a potential distributed denial of service (DDOS) attack; and
while the first VNIC is in the protected mode, causing one or more packets destined for the first compute instance to be redirected to a DDOS scrubber system instead of being sent to a first network virtualization device (NVD) implementing the first VNIC;
wherein the first VNIC is associated with a first overlay address configured for the first compute instance, and the first overlay address is associated with a substrate address associated with the NVD implementing the first VNIC.

14. The method of claim 13, wherein initiating the protected mode for the first VNIC comprises:
creating a first shadow VNIC corresponding to the first VNIC associated with the first compute instance;
associating the first overlay address with the first shadow VNIC;
associating the first shadow VNIC with a substrate address associated with the DDOS scrubber system; and
publishing, to the overlay network provided by the cloud service provider infrastructure, information indicative of the first shadow VNIC.

15. The method of claim 14, wherein causing one or more packets to be redirected to the DDOS scrubber system comprises:
for a first packet in the one or more packets, the first packet being destined for the first overlay address configured for the first compute instance;
determining that, for the first overlay address, the first packet is to be sent to the substrate address associated with the DDOS scrubber system; and
sending the first packet to the DDOS scrubber system.

16. The method of claim 14, wherein the DDOS scrubber system includes at least one host machine configured to implement the first shadow VNIC or at least one NVD configured to implement the first shadow VNIC.

17. The method of claim 13, further comprising:
performing, by the DDOS scrubber system, at least one action on the one or more packets;
wherein the performing comprises dropping the one or more packets, throttling the one or more packets, or forwarding the one or more packets to the NVD.

18. A method, comprising:
monitoring network traffic received by a plurality of network resources in one or more overlay networks provided by a cloud service provider infrastructure, the network traffic destined for a first compute instance;
based at least in part on the monitoring, initiating a protected mode for a first network resource from the plurality of network resources to protect the first network resource from a potential distributed denial of service (DDOS) attack, the first network resource being associated with the first compute instance; and
while the first network resource is in the protected mode, causing one or more packets destined for the first compute instance to be redirected to a DDOS scrubber system instead of being sent to the first network resource.

19. The method of claim 18, wherein:
the first network resource is a network virtualization device (NVD) implementing a first virtual network interface card (VNIC) associated with the first compute instance in a first overlay network from the one or more overlay networks, wherein the first VNIC enables the first compute instance to be part of the first overlay network, wherein the first VNIC is associated with a first overlay address configured for the first compute instance, wherein the first overlay address is associated with a substrate address associated with the NVD;
initiating the protected mode for the NVD comprises:
creating a first shadow VNIC corresponding to the first VNIC associated with the first compute instance,
associating the first overlay address with the first shadow VNIC,
associating the first shadow VNIC with a substrate address associated with the DDOS scrubber system, and
publishing, to the one or more overlay networks provided by the cloud service provider infrastructure, information indicative of the set of one or more shadow VNICs;
causing one or more packets to be redirected to the DDOS scrubber system comprises:
for a first packet in the one or more packets, the first packet being destined for the first overlay address configured for the first compute instance,
determining that, for the first overlay address, the first packet is to be sent to the substrate address associated with the DDOS scrubber system, and
sending the first packet to the DDOS scrubber system; and the DDOS scrubber system determines whether the first packet is to be forwarded to the NVD.

20. The method of claim 18, wherein the first network resource is a virtual network interface card (VNIC) associated with the first compute instance in a first overlay network from the one or more overlay networks, wherein the VNIC enables the first compute instance to be part of the first overlay network, wherein the VNIC is associated with a first overlay address configured for the first compute instance, wherein the first overlay address is associated with a substrate address associated with an network virtualization device (NVD) implementing the VNIC;
initiating the protected mode for the VNIC comprises:
creating a shadow VNICs corresponding to the VNIC associated with the first compute instance,
associating the first overlay address with the shadow VNIC,
associating the shadow VNIC with a substrate address associated with the DDOS scrubber system, and
publishing, to the one or more overlay networks provided by the cloud service provider infrastructure, information indicative of the set of one or more shadow VNICs;
causing one or more packets to be redirected to the DDOS scrubber system comprises:
for a first packet in the one or more packets, the first packet being destined for the first overlay address configured for the first compute instance,
determining that, for the first overlay address, the first packet is to be sent to the substrate address associated with the DDOS scrubber system, and
sending the first packet to the DDOS scrubber system; and
the DDOS scrubber system determines whether the first packet is to be forwarded to the NVD.
